(19) United States
(12) Patent Application Publication
(10) Pub. No.: US 2015/0169082 A1
(43) Pub. Date: Jun. 18, 2015

(54) Method and Device for Filter-Processing Imaging Information of Emission Light Source

(71) Applicant: Jeenon, LLC, Santa Clara, CA (US)

(72) Inventors: Dongge Li, Xi'an (CN); Wei Wang, Xi'an (CN)

(21) Appl. No.: 14/371,408

(22) PCT Filed: Jan. 9, 2013
(86) PCT No.: PCT/CN2013/070288

§ 371 Date: Jul. 9, 2014

(30) Foreign Application Priority Data
Jan. 9, 2012 (CN) CN201210004569.6

(51) Int. Cl. G06F 3/03

(52) U.S. Cl. CPC G06F 3/0304

(57) ABSTRACT

An objective of the present invention is to provide a method and apparatus for screening imaging information of a light-emitting source; through obtaining a plurality of pieces of candidate imaging information in an imaging frame of a light-emitting source; obtaining feature information of the candidate imaging information; screening the plurality of pieces of candidate imaging information based on the feature information, so as to obtain imaging information corresponding to the light-emitting source. Compared with the prior art, the present invention effectively eliminates potential interferences in actual application by obtaining a plurality of pieces of candidate imaging information in an imaging frame of a light-emitting source, and screening the plurality of pieces of candidate imaging information based on the feature information of the candidate imaging information to obtain imaging information corresponding to the light-emitting source, such that the imaging information of the light-emitting source is obtained more accurately.

### FIELD OF THE INVENTION

The present invention relates to the field of intelligent control technology, and more specifically, to a technology of screening imaging information of a light-emitting source.

### BACKGROUND OF THE INVENTION

In the field of intelligent control such as smart TV, somatosensory interaction, and virtual reality, etc., corresponding control operations, such as turning on or off a controlled device, are usually performed through detecting by a detecting means certain signals emitted by an emitting means, for example, an optical signal transmitted by a light-emitting source such as a spot light source, a plane light source, or a ball light source, etc. However, noise points such as cigarette butt might exist in practical application, and it is always inaccurate in collecting the optical signals; as a result, the control of a controlled device is not accurate enough, which affects use experience of users.

Thus, it is an imminent problem for those skilled in the art to solve how to accurately obtain imaging information corresponding to the light-emitting source in view of the above drawbacks.

### SUMMARY OF THE INVENTION

An objective of the present invention is to provide a method and apparatus for screening imaging information of a light-emitting source.

According to one aspect of the present invention, there is provided a method of screening imaging information of a light-emitting source, wherein the method comprises:

a. obtaining a plurality of pieces of candidate imaging information in an imaging frame of a light-emitting source;

b. obtaining feature information of the candidate imaging information;

c. screening the plurality of pieces of candidate imaging information based on the feature information, so as to obtain imaging information corresponding to the light-emitting source.

Preferably, wherein the step c comprises:
screening the plurality of pieces of candidate imaging information based on the feature information in combination with a predetermined feature threshold, so as to obtain the imaging information corresponding to the light-emitting source.

More preferably, wherein the step c comprises:
screening the plurality of pieces of candidate imaging information based on a maximum possibility of the feature information, so as to obtain the imaging information corresponding to the light-emitting source.

Preferably, wherein the feature information comprises a light spot variation pattern, wherein the step b comprises:
detecting a light spot variation pattern of the candidate imaging information;

wherein, the step c comprises:
matching the light spot variation pattern with a predetermined light spot variation pattern of the light-emitting source so as to obtain corresponding first match information;
based on the first matching information, screening the plurality of pieces of candidate imaging information so as to obtain the imaging information corresponding to the light-emitting source.

More preferably, wherein the light spot variation pattern comprises at least one of the following items:
bright-dark alternative variation;
wavelength alternative variation
light spot geometrical feature variation;
flicker frequency alternative variation;
brightness distribution alternative variation.

Preferably, wherein the step c comprises:
screening the plurality of pieces of candidate imaging information based on the feature information in combination with background reference information corresponding to the light-emitting source, so as to obtain imaging information corresponding to the light-emitting source.

More preferably, wherein the method further comprises:
obtaining a plurality of pieces of zero input imaging information corresponding to the light-emitting source in a zero input state;
performing feature analysis of the plurality of pieces of zero input imaging information to obtain the background reference information.

Preferably, wherein the method further comprises:
clustering the plurality of pieces of candidate imaging information, so as to obtain an imaging clustering result;

wherein, the step b comprises:
extracting a clustering feature corresponding to the imaging clustering result, to act as the feature information.

Preferably, wherein the step b comprises:
obtaining the feature information of the candidate imaging information based on imaging analysis of the candidate imaging information;

wherein the feature information comprises at least one of the following items:
wavelength information of a light source corresponding to the candidate imaging information;
flickering frequency corresponding to the candidate imaging information;
brightness information corresponding to the candidate imaging information;
light emitting pattern corresponding to the candidate imaging information;
geometrical information corresponding to the candidate imaging information;
distance information between the light source corresponding to the candidate imaging information and the camera;
color distribution information corresponding to the candidate imaging information.

Preferably, wherein the step b comprises:
obtaining the feature information of the candidate imaging information based on imaging analysis of the candidate imaging information, wherein the feature information comprises wavelength information and/or flickering frequency of a light source corresponding to the candidate imaging information.

Preferably, wherein the step b comprises:
obtaining the feature information of the candidate imaging information based on imaging analysis of the candidate imaging information, wherein the feature information comprises a light emitting pattern corresponding to the candidate imaging information.

Preferably, wherein the step b comprises:
obtaining the feature information of the candidate imaging information based on imaging analysis of the candidate imaging information, wherein the feature information comprises geometrical information corresponding to the candidate imaging information.

Preferably, wherein the step b comprises:
obtaining feature information of the candidate imaging information based on the imaging analysis of the candidate imaging information, wherein the feature information comprises distance information between the candidate imaging information and a target object.

Preferably, wherein the step b comprises:
obtaining feature information of the candidate imaging information based on imaging analysis of the candidate imaging information, wherein the feature information comprises color distribution information corresponding to the candidate imaging information;

wherein, the step c comprises:
matching the color distribution information corresponding to the candidate imaging information with a predetermined color distribution information so as to obtain corresponding second match information;
based on the second match information, screening the plurality of pieces of candidate imaging information so as to obtain imaging information corresponding to the light-emitting source.

As one of preferred embodiments of the present invention, wherein the method further comprises:
obtaining any two imaging frames of the light-emitting source, wherein the any two imaging frames comprises a plurality of pieces of imaging information;
performing difference calculation to the any two imaging frames, so as to obtain a difference imaging frame of the light-emitting source, wherein the difference imaging frame comprises difference imaging information;

wherein, the step a comprises:
obtaining difference imaging information in the difference imaging frame, to act as the candidate imaging information.

As one of preferred embodiments of the present invention, wherein the light-emitting source comprises a moving light-emitting source, wherein the method further comprises:
obtaining a consecutive plurality of imaging frames before the current imaging frame of the light-emitting source, wherein the consecutive plurality of imaging frames each comprises a plurality of pieces of imaging information;
detecting a moving light spot in the consecutive plurality of imaging frames and trace information of the moving light spot;
determining predicted position information of the moving light spot in the current imaging frame based on the trace information of the moving light spot in combination with a motion model;

wherein, the step a comprises:
obtaining a plurality of pieces of candidate imaging information in the current imaging frame;

wherein, the step c comprises:
screening the plurality of pieces of candidate imaging information based on the feature information in combination with the predicted position information, so as to obtain the imaging information corresponding to the light-emitting source.

Preferably, wherein the motion model comprises at least one of the following items:
speed-based motion model;
acceleration-based motion model; More preferably, wherein the method further comprises:
updating the motion model based on the trace information in combination with position information of the candidate imaging information in the current imaging frame.

As one of preferred embodiments of the present invention, wherein the method further comprises:
determining a flickering frequency of the light-emitting source;
determining the frame number of the consecutive plurality of imaging frames obtained before the current imaging frame of the light-emitting source based on an exposure frequency of a camera and the flickering frequency of the light-emitting source, wherein the exposure frequency of the camera is more than twice of the flickering frequency of the light-emitting source;
obtaining the consecutive plurality of imaging frames before the current imaging frame based on the frame number, wherein the current imaging frame and the consecutive plurality of imaging frames each comprises a plurality of pieces of imaging information;
performing difference calculation between the consecutive plurality of imaging frames and the current imaging frame, respectively, so as to obtain a plurality of difference imaging frames of the light-emitting source;

x performing frame image processing to the plurality of difference imaging frames, so as to obtain a frame processing result;

wherein, the step a comprises:
screening a plurality of pieces of imaging information in the current imaging frame based on the frame processing result, so as to obtain the candidate imaging information.

Preferably, wherein the step b comprises:
determining a flickering frequency of the candidate imaging information based on imaging analysis of the candidate imaging information in combination with the frame processing result;

wherein, the step c comprises:
screening the plurality of pieces of candidate imaging information based on the flickering frequency of the candidate imaging information in combination with the flickering frequency of the light-emitting source, so as to obtain the imaging information corresponding to the light-emitting source.

Preferably, wherein the step x comprises:
performing threshold binarization to imaging information in the plurality of difference imaging frames, respectively, so as to generate a plurality of candidate binarization images;
merging the plurality of candidate binarization images so as to obtain the frame processing result.

More preferably, wherein the step x comprises:
merging the plurality of difference image frames, so as to obtain a merged difference imaging frame;
performing frame image processing to the merge processed difference imaging frame, so as to obtain the frame processing result.

Preferably, wherein the light-emitting source comprises a moving light-emitting source, wherein the method further comprises:
determining that the exposure frequency of the camera is more than twice of the flickering frequency of the light-emitting source;
obtaining a consecutive plurality of imaging frames, wherein the consecutive plurality of imaging frames each comprises a plurality of pieces of imaging information;
performing difference calculation to every two adjacent imaging frames in the consecutive plurality of imaging frames, so as to obtain difference imaging information.
detecting a moving light spot in the consecutive plurality of imaging frames and trace information of the moving light spot;

wherein, the step a comprises:
taking the moving light spot as the candidate imaging information;

wherein, the step b comprises:
determining a flickering frequency of the candidate imaging information based on the trace information of the moving light spot in combination with the difference imaging information;

wherein, the step c comprises:
screening the plurality of pieces of candidate imaging information based on the flickering frequency of the candidate imaging information in combination with the flickering frequency of the light-emitting source, so as to obtain the imaging information corresponding to the light-emitting source.

According to another aspect of the present invention, there is provided an apparatus of screening imaging information of a light-emitting source, wherein the apparatus comprises:

an imaging obtaining means for obtaining a plurality of pieces of candidate imaging information in an imaging frame of a light-emitting source;

a feature obtaining means for obtaining feature information of the candidate imaging information;

an imaging screening means for screening the plurality of pieces of candidate imaging information based on the feature information, so as to obtain imaging information corresponding to the light-emitting source.

Preferably, wherein the imaging screening means is for:
screening the plurality of pieces of candidate imaging information based on the feature information in combination with a predetermined feature threshold, so as to obtain the imaging information corresponding to the light-emitting source.

More preferably, wherein the imaging screening means is for:
screening the plurality of pieces of candidate imaging information based on a maximum possibility of the feature information, so as to obtain the imaging information corresponding to the light-emitting source.

Preferably, wherein the feature information comprises a light spot variation pattern, wherein the feature obtaining means is for:
detecting a light spot variation pattern of the candidate imaging information;

wherein, the imaging screening means is for:
matching the light spot variation pattern with a predetermined light spot variation pattern of the light-emitting source so as to obtain corresponding first match information;
based on the first matching information, screening the plurality of pieces of candidate imaging information so as to obtain the imaging information corresponding to the light-emitting source.

Preferably, wherein the light spot variation pattern comprises at least one of the following items:
bright-dark alternative variation;
wavelength alternative variation
light spot geometrical feature variation;
flicker frequency alternative variation;
brightness distribution alternative variation.

Preferably, wherein the imaging screening means is for:
screening the plurality of pieces of candidate imaging information based on the feature information in combination with background reference information corresponding to the light-emitting source, so as to obtain imaging information corresponding to the light-emitting source.

More preferably, wherein the apparatus further comprises a background obtaining means for:
obtaining a plurality of pieces of zero input imaging information corresponding to the light-emitting source in a zero input state;
performing feature analysis of the plurality of pieces of zero input imaging information to obtain the background reference information.

Preferably, wherein the apparatus further comprises a clustering means for:
clustering the plurality of pieces of candidate imaging information, so as to obtain an imaging clustering result;

wherein, the feature obtaining means is for:
extracting a clustering feature corresponding to the imaging clustering result, to act as the feature information.

Preferably, wherein the feature obtaining means is for:
obtaining the feature information of the candidate imaging information based on imaging analysis of the candidate imaging information;

wherein the feature information comprises at least one of the following items:
wavelength information of a light source corresponding to the candidate imaging information;
flickering frequency corresponding to the candidate imaging information;
brightness information corresponding to the candidate imaging information;
light emitting pattern corresponding to the candidate imaging information;
geometrical information corresponding to the candidate imaging information;
distance information between the light source corresponding to the candidate imaging information and the camera;
color distribution information corresponding to the candidate imaging information.

Preferably, wherein the feature obtaining means is for:
obtaining the feature information of the candidate imaging information based on imaging analysis of the candidate imaging information, wherein the feature information comprises wavelength information and/or flickering frequency of a light source corresponding to the candidate imaging information.

Preferably, wherein the feature obtaining means is for:
obtaining the feature information of the candidate imaging information based on imaging analysis of the candidate imaging information, wherein the feature information comprises a light emitting pattern corresponding to the candidate imaging information.

Preferably, wherein the feature obtaining means is for:
obtaining the feature information of the candidate imaging information based on imaging analysis of the candidate imaging information, wherein the feature information comprises geometrical information corresponding to the candidate imaging information.

Preferably, wherein the feature obtaining means is for:
obtaining feature information of the candidate imaging information based on the imaging analysis of the candidate imaging information, wherein the feature information comprises distance information between the candidate imaging information and a target object.

Preferably, wherein the feature obtaining means is for:
obtaining feature information of the candidate imaging information based on imaging analysis of the candidate imaging information, wherein the feature information comprises color distribution information corresponding to the candidate imaging information;

wherein, the imaging screening means is for:
matching the color distribution information corresponding to the candidate imaging information with a predetermined color distribution information so as to obtain corresponding second match information;
based on the second match information, screening the plurality of pieces of candidate imaging information so as to obtain imaging information corresponding to the light-emitting source.

As one of the preferred embodiments of the present invention, wherein the apparatus further comprises:

a first frame obtaining means for obtaining any two imaging frames of the light-emitting source, wherein the any two imaging frames comprises a plurality of pieces of imaging information;

a first difference calculating means for performing difference calculation to the any two imaging frames, so as to obtain a difference imaging frame of the light-emitting source, wherein the difference imaging frame comprises difference imaging information;

wherein, the imaging obtaining means is for:
obtaining difference imaging information in the difference imaging frame, to act as the candidate imaging information.

As one of the preferred embodiments of the present invention, wherein the light-emitting source comprises a moving light-emitting source, wherein the apparatus further comprises:

a second frame obtaining means for obtaining a consecutive plurality of imaging frames before the current imaging frame of the light-emitting source, wherein the consecutive plurality of imaging frames each comprises a plurality of pieces of imaging information;

a first detecting means for detecting a moving light spot in the consecutive plurality of imaging frames and trace information of the moving light spot;

a first predicting means for determining predicted position information of the moving light spot in the current imaging frame based on the trace information of the moving light spot in combination with a motion model;

wherein, the imaging obtaining means is for:
obtaining a plurality of pieces of candidate imaging information in the current imaging frame;

wherein, the imaging screening means is for:
screening the plurality of pieces of candidate imaging information based on the feature information in combination with the predicted position information, so as to obtain the imaging information corresponding to the light-emitting source.

Preferably, wherein the motion model comprises at least one of the following items:
speed-based motion model;
acceleration-based motion model;

More preferably, wherein the apparatus further comprises an updating means for:
updating the motion model based on the trace information in combination with position information of the candidate imaging information in the current imaging frame.

As one of the preferred embodiments of the present invention, wherein the apparatus further comprises:

a first frequency determining means for determining a flickering frequency of the light-emitting source;

a frame number determining means for determining the frame number of the consecutive plurality of imaging frames obtained before the current imaging frame of the light-emitting source based on an exposure frequency of a camera and the flickering frequency of the light-emitting source, wherein the exposure frequency of the camera is more than twice of the flickering frequency of the light-emitting source;

a third frame obtaining means for obtaining the consecutive plurality of imaging frames before the current imaging frame based on the frame number, wherein the current imaging frame and the consecutive plurality of imaging frames each comprises a plurality of pieces of imaging information;

a second difference calculating means for performing difference calculation between the consecutive plurality of imaging frames and the current imaging frame, respectively, so as to obtain a plurality of difference imaging frames of the light-emitting source;

a frame image processing means for performing frame image processing to the plurality of difference imaging frames, so as to obtain a frame processing result;

wherein, the imaging obtaining means is for:
screening a plurality of pieces of imaging information in the current imaging frame based on the frame processing result, so as to obtain the candidate imaging information.

Preferably, wherein the feature obtaining means is for:
determining a flickering frequency of the candidate imaging information based on imaging analysis of the candidate imaging information in combination with the frame processing result;

wherein, the imaging screening means is for:
screening the plurality of pieces of candidate imaging information based on the flickering frequency of the candidate imaging information in combination with the flickering frequency of the light-emitting source, so as to obtain the imaging information corresponding to the light-emitting source.

Preferably, wherein the frame image processing means is for:
performing threshold binarization to imaging information in the plurality of difference imaging frames, respectively, so as to generate a plurality of candidate binarization images;
merging the plurality of candidate binarization images so as to obtain the frame processing result.

More preferably, wherein the frame image processing means is for:
merging the plurality of difference image frames, so as to obtain a merged difference imaging frame;
performing frame image processing to the merge processed difference imaging frame, so as to obtain the frame processing result.

Preferably, wherein the light-emitting source comprises a moving light-emitting source, wherein the apparatus further comprises:

a second frequency determining means for determining that the exposure frequency of the camera is more than twice of the flickering frequency of the light-emitting source;

a fourth frame obtaining means for obtaining a consecutive plurality of imaging frames, wherein the consecutive plurality of imaging frames each comprises a plurality of pieces of imaging information;

a third difference calculating means for performing difference calculation to every two adjacent imaging frames in the consecutive plurality of imaging frames, so as to obtain difference imaging information.

a second detecting means for detecting a moving light spot in the consecutive plurality of imaging frames and trace information of the moving light spot;

wherein, the imaging obtaining means is for:
taking the moving light spot as the candidate imaging information;

wherein, the feature obtaining means is for:
determining a flickering frequency of the candidate imaging information based on the trace information of the moving light spot in combination with the difference imaging information;

wherein, the imaging screening means is for:
screening the plurality of pieces of candidate imaging information based on the flickering frequency of the candidate imaging information in combination with the flickering frequency of the light-emitting source, so as to obtain the imaging information corresponding to the light-emitting source.

Compared with the prior art, the present invention effectively eliminates potential interferences in actual application by obtaining a plurality of pieces of candidate imaging information in an imaging frame of a light-emitting source, and screening the plurality of pieces of candidate imaging information based on the feature information of the candidate imaging information to obtain imaging information corresponding to the light-emitting source, such that the imaging information of the light-emitting source is obtained more accurately.

### BRIEF DESCRIPTION OF THE SEVERAL VIEWS OF THE DRAWINGS

Through reading the detailed description of the non-limiting embodiments with reference to the following accompanying drawings, the other features, objectives, and advantages of the present invention will become more apparent.

FIG. 1 illustrates a schematic diagram of an apparatus for screening imaging information of a light-emitting source according to one aspect of the present invention;

FIG. 2 illustrates a schematic diagram of an apparatus for screening imaging information of a light-emitting source according to one preferred embodiment of the present invention;

FIG. 3 illustrates a schematic diagram of an apparatus for screening imaging information of a light-emitting source according to another preferred embodiment of the present invention;

FIG. 4 illustrates a schematic diagram of an apparatus for screening imaging information of a light-emitting source according to one further preferred embodiment of the present invention;

FIG. 5 illustrates a flow chart of a method of screening imaging information of a light-emitting source according to another aspect of the present invention;

FIG. 6 illustrates a flow chart of a method of screening imaging information of a light-emitting source according to one preferred embodiment of the present invention;

FIG. 7 illustrates a flow chart of a method of screening imaging information of a light-emitting source according to another preferred embodiment of the present invention;

FIG. 8 illustrates a flow chart of a method of screening imaging information of a light-emitting source according to one further preferred embodiment of the present invention;

FIG. 9 illustrates color distribution information of the imaging information of a light-emitting source according to a further preferred embodiment of the present invention.

Same or like reference numerals in the accompanying drawings represent the same or like components.

### DETAILED DESCRIPTION OF THE INVENTION

Hereinafter, the present invention will be further described in detail with reference to the accompanying drawings.

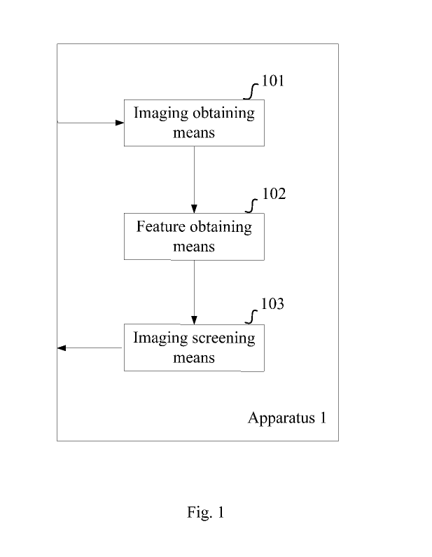

FIG. 1 illustrates a schematic diagram of an apparatus for screening imaging information of a light-emitting source according to one aspect of the present invention. The apparatus 1 comprises an imaging obtaining means 101, a feature obtaining means 102, and an imaging screening means 103.

In this embodiment, the imaging obtaining means 101 obtains a plurality of pieces of candidate imaging information in an imaging frame of the light-emitting source. Specifically, the imaging obtaining means 101 obtains a plurality of pieces of candidate imaging information in an imaging frame of a light-emitting source through performing a match query in an imaging base, or through interacting with other means of the apparatus 1; or, obtains an imaging frame of the light-emitting source as shot by a camera, and obtains a plurality of pieces of candidate imaging information in an imaging frame of the light-emitting source through performing image analysis on the imaging frame of the light-emitting source. Here, the light-emitting source includes, but not limited, to a spot light source, a plane light source, a ball light source, or any other light source that emits light at a certain light emitting frequency, for example, an LED visible light source, an LED infrared light source, an OLED (Organic Light Emitting Diode) light source, and a laser light source, etc. A plurality of pieces of candidate imaging information in the imaging frame includes one or more pieces of imaging information corresponding to one or more light-emitting sources, as well as imaging information corresponding to a noise point such as a cigarette butt or other lamp light.

Here, the imaging base stores a great amount of imaging frames corresponding to the light-emitting source, as well as candidate imaging information in the great amount of imaging frames; the imaging base may be provided in the apparatus 1 or a third party apparatus connected to the apparatus 1 via a network.

Those skilled in the art should understand that the above manner of obtaining imaging information is only exemplary, and other existing manner of obtaining imaging information or a manner possibly evolved in the future, if applicable to the present invention, should also be included within the protection scope of the present invention, which are incorporated here by reference.

The following embodiments will only take an LED as example. Those skilled in the art should understand that other existing light-emitting sources or those possibly evolved in the future, particularly, an OLED, if applicable to the present invention, should also be included within the protection scope of the present invention, which are incorporated here by reference. Here, the LED (Light Emitting Diode) is a solid semiconductor device capable of converting electrical energy into visible light. It may directly converting electricity into light and takes the light as a control signal.

The feature obtaining means 102 obtains feature information of the candidate imaging information. Specifically, the feature obtaining means 102 obtains feature information of the plurality of pieces of candidate imaging information through interaction with for example a feature information base. Here, the feature information base stores feature information of the candidate imaging information and establishes or updates the feature information base according to analysis on the candidate imaging information in a new imaging frame as shot by a camera for each time. Or, preferably, the feature obtaining means 102 determines the feature information of the candidate imaging information based on an imaging analysis on the candidate imaging information, wherein the feature information comprises at least one of the following items:
wavelength information of a light source corresponding to the candidate imaging information;
flickering frequency corresponding to the candidate imaging information;
brightness information corresponding to the candidate imaging information;
light emitting pattern corresponding to the candidate imaging information;
geometrical information corresponding to the candidate imaging information;
distance information between the light source corresponding to the candidate imaging information and the camera.
color distribution information corresponding to the candidate imaging information.

Specifically, the feature obtaining means 102 obtains feature information of the candidate imaging information based on a plurality of pieces of candidate imaging information in an LED imaging frame as obtained by the imaging obtaining means 101 through performing imaging analysis on the plurality of pieces of candidate imaging information, for example, performing image processing such as image digitalization and Hough-transformation to the LED imaging frame.

Here, as a light source corresponding to the candidate imaging information, the LED or noise point has a certain wavelength and may form a light with a color corresponding to the wavelength; the feature obtaining means 102 obtains the wavelength information of the light source corresponding to the candidate imaging information through for example detecting and analyzing the (R, G, B) value or (H, S, V) value of a pixel point in the LED imaging frame.

For another example, when the LED or noise point emits light at a certain flickering frequency, for example, flickers 10 times per second, the feature obtaining means 102 may determine, through detecting a plurality of LED imaging frames, based on the bright-dark variation of the candidate imaging information in each LED imaging frame, the flickering frequency corresponding to the candidate imaging information. Here, the flickering may also comprises emitting light with different brightness in alternation, instead of emitting light merely in a bright-and-dark pattern.

When the LED or noise spot emits light with a certain brightness (here, the brightness indicates a luminous flux of the LED or noise spot at a unit solid angle unit area in a particular direction), the feature obtaining means 102 determines the brightness information corresponding to the candidate imaging information, for example through calculating an average or sum of gray values of the plurality of pieces of candidate imaging information in the LED imaging frame; or, determines through a brightness value of an optical pixel spot in the LED imaging frame.

When the LED or noise spot emits light with a certain light emitting pattern, for example, emitting light with a pattern in which the fringe is bright and the center is dark, the feature obtaining means 102 may determine a light emitting pattern corresponding to the candidate imaging information through detecting and analyzing the (R, G, B) value, (H, S, V) value or brightness value of each pixel spot in the LED imaging frame.

Here, the light emitting pattern includes, but not limited to, shape, wavelength, flickering frequency, brightness or brightness distribution, etc.

When the LED or noise spot emits light with a certain geometrical shape, for example, the LED emits light in shapes such as triangle, round, or square, or a plurality of LEDs combine to form a light emitting pattern of a certain shape, the feature obtaining means 102, through detecting and analyzing each pixel spot in the LED imaging frame, determines geometrical information corresponding to the candidate imaging information, such as area, shape, relative location between a plurality of pieces of imaging information, a pattern formed by the plurality of pieces of imaging information, etc.

For another example, as a light source corresponding to candidate imaging information, the distance between the LED or noise spot and the camera is different; the feature obtaining means 102 obtains corresponding information such as radius, brightness, and the like through analyzing the candidate imaging information of the LED or noise spot in the LED imaging frame, and further calculates the distance information between the LED or noise spot and the camera based on the above information.

For a further example, the candidate imaging information corresponding to the LED or noise spot in the LED imaging frame might have corresponding color distribution information. For example, when using a color camera, the imaging information of the color LED on the color camera will generate different color distribution information at different distances. For example, when the emitting means is relatively far from the color camera, the imaging information corresponding to the color LED will generally assume a common colorful round speckle with a relatively small round speckle radius; while when the emitting means is relatively near to the color camera, the color LED will generally, due to exposure, have a corresponding imaging information assuming a light spot structure with the middle having an overexposure white speckle while the outer periphery having a colorful loop-shaped halo, and at this point, the round speckle has a relatively large round speckle radius. The feature obtaining means 102 obtains the corresponding color distribution information through analyzing the corresponding candidate imaging information of the color LED or noise spot in the LED imaging frame.

Preferably, the feature obtaining means 102 obtains the feature information of the candidate imaging information based on the imaging analysis of the candidate imaging information, wherein the feature information comprises distance information of the candidate imaging information away from the target object. For example, for a human face or hand gesture, and the like, they likewise have corresponding imaging information in the LED imaging frame, and with such imaging information as a target object, the feature obtaining means 102 analyzes the corresponding candidate imaging information of the LED or noise spot in the LED imaging frame, and then calculates to obtain the distance information of the candidate imaging information away from the target object based on the information.

Preferably, the feature obtaining means 102 obtains the feature information of the candidate imaging information based on the imaging analysis of the candidate imaging information, wherein the feature information comprises a light spot variation pattern corresponding to the candidate imaging information, the light spot variation pattern includes, but not limited to, bright-dark alternative variation, wavelength alternative variation, light spot geometrical feature variation, flicker frequency alternative variation, brightness distribution alternative variation, etc.; the light spot geometrical feature variation for example comprises light spot number variation, geometrical shape variation, or a variation combining the above two variations.

Specifically, the light-emitting source has a predetermined light spot variation pattern. For example, through programming the emitting means circuit, different voltages or currents or different current paths are generated, to drive one or more boarded LEDs to generate various kinds of light spot feature variation occurring in alternation. These controllable light spot features include for example, brightness, light emitting shape, light emitting wavelength (for example, color), light emitting area, etc. The generated light spot variation pattern may be an alternative periodic variation of one light spot feature or a combined regular alternative variation of a plurality of light spot features.

With the light spot variation pattern with bright-dark alternative variation as an example, the light spot variation pattern with bright-dark alternative variation includes, but not limited to:

1) With bright or dark of the light-emitting source within a predefined duration as a signal value, the minimum duration time of the bright or dark is at least no lower than the exposure time of the camera unit; preferably, the minimum duration time of the bright or dark is no lower than a sum of the exposure time of the camera unit and the interval between two exposure times.

For example, with bright or dark of the light-emitting source within a predefined duration as a signal value, for example, a continuous bright of 10 ms has a value 1, while a continuous dark of 10 ms has a value 0, then the signal value of 20 ms continuous bright and 10 ms continuous dark is 110. Here, the minimum duration of bright or dark is at least no lower than the exposure time of the camera unit. Preferably, the minimum duration time of bright or dark is no lower than the sum of the exposure time of the camera unit and the interval between two exposure times.

2) With the interval between two bright-dark alternation times of the light-emitting source as the signal value, wherein the minimum time interval between two times of bright-dark alternations is at least twice of the exposure time of the camera unit; preferably, the minimum time interval between two times of bright-dark alternations is at least twice of the sum of the exposure time of the camera unit and the interval between two exposures.

For example, with the time interval between two times of bright-dark alternations of the light-emitting source, i.e., the flickering time interval, as the signal value, for example, the 10 ms time interval between two times of flickers has a signal value 1, and the 20 ms time interval between two times of flickers has a signal value 2; then when the time interval between the first and second flickers is 10 ms and the time interval between the second and third flickers is 20 ms, the generated signal value is 12. Here, the minimum time interval between two times of bright-dark alterations, i.e., the flickering time interval, should be at least twice of the exposure time of the camera unit. Preferably, the minimum time interval between two times of bright-dark alterations is at least twice of the sum of the exposure time of the camera unit and the time interval between two exposures.

3) With the bright-dark alterative frequency of the light-emitting source as the signal value, the exposure frequency of the camera unit is at least twice of the bright-dark alterative frequency, wherein the exposure frequency refers to the exposure times of the camera unit within a unit time.

For example, with the bright-dark alterative frequency of the light-emitting source, i.e., the flicker frequency, as the signal value, if the signal value for occurrence of flicker once within 1 s is 1, and twice is 2, then when one flicker occurs within the 1st second and two flickers occur within the 2nd second, the generated signal value is 12. Here, the exposure frequency of the camera unit is at least twice of the bright-dark alternative frequency.

For another example, the light spot variation pattern may comprise a flickering frequency alternative variation. Through performing programming control to the LED control circuit, flickering frequency of the LED light spot may be controlled, and alternative variation is performed based on different flickering frequency. For example, the light spot flickers 10 times in the first second and flickers 20 times in the second second, and so forth to perform the alternative variations. The flickering frequency with a regular alternative variation is used as a specific light spot variation pattern and further as feature information for screening imaging information.

For another example, the light spot variation pattern may further comprise a brightness distribution alternative variation. Through performing programming control to the LED control circuit, brightness distribution of the LED light spot may be controlled, and alternative variation is performed based on different brightness distributions. For example, the light spot assumes a brightness distribution with light in the center while dark in the periphery within the first second and a brightness distribution with dark in the middle and light in the periphery within the second second, and so forth to perform the alternative variations; for another example, the alternative variation is performed with a brightness distribution where the central light speckle has a radius R1 within the first second, and a brightness distribution where the central light speckle of the light spot has a radius R2 within the second second, and so forth to perform the alternative variations. These brightness distributions with a regular alternative variation are used as a specific light spot variation pattern and further as feature information for screening imaging information.

Preferably, the light-emitting source may further send the control signal with reference to the above arbitrary plurality of predetermined light spot variation patterns, for example, sending the control signal with the light spot variation pattern with bright-dark alternative variation plus wavelength alternative variation. With the LED as an example, the LED, for example, emits light with the light spot variation pattern with red-green plus bright-dark alternation.

More preferably, the light-emitting source may also use a light spot variation pattern of a combination of multiple different wavelengths (colors) to send a control signal, and its alternation may be embodied as alternating with combinations of different colors. Here, a combination of different wavelengths (colors) may form a light-emitting unit through a dual-color LED or more than two LEDs having different wavelengths (colors). More preferably, the light-emitting source may send a control signal using a plurality of different wavelengths (colors) in conjunction with a light spot variation pattern of the bright-dark alternative variation and the light-spot geometrical feature variation. For example, at any time, different light-emitting color distributions may be formed by merely lighting one LED thereby or by lighting the two LEDs simultaneously; or one LED lights constantly, while the other flickers at a certain frequency, thereby achieving a light-spot variation pattern with different color combinations.

Preferably, noise-resistance may be realized in case of sending a control signal by adopting an alternative light-spot variation pattern in which one LED lights constantly while the other flickers at a certain frequency. For example, this light emitting pattern first uses two LED light-emitting spots to screen off a noise spot of individual light-emitting spots in the natural world; this light emitting pattern then uses an LED light-emitting spot with a particular color distribution to screen off those noise spots that are not of the particular color in the natural world; further, the light emitting pattern screens off other noise spots which are not in the light emitting pattern by one LED constantly lighting and the other LED flickering at a certain frequency.

Those skilled in the art should understand that the above feature information and manners of obtaining the feature information is only exemplary, and other existing feature information or manner of obtaining the feature information or the feature information and the manner of obtaining the feature information possibly evolved in the future, if applicable to the present invention, should also be included within the protection scope of the present invention, which are incorporated here by reference.

The imaging screening means 103 screens the plurality of pieces of candidate imaging information based on the feature information so as to obtain the imaging information corresponding to the LED. Specifically, the manners in which the imaging screening means 103 screens the plurality of pieces of candidate imaging information include, but not limited to:

1) screening the plurality of pieces of candidate imaging information based on the feature information obtained by the feature obtaining means 102 in combination with a predetermined feature threshold, so as to obtain the imaging information corresponding to the LED. For example, the feature information as obtained by the feature obtaining means 102 comprises brightness information of the plurality of pieces of candidate imaging information; the imaging screening means 103 compares the brightness information with a predetermined brightness threshold, for example, comparing with a predetermined LED light spot brightness threshold; if the brightness information is within the scope of the brightness threshold, the candidate imaging information is reserved; otherwise, it is deleted so as to implement screening to the plurality of pieces of candidate imaging information and finally obtain the imaging information corresponding to the LED. For another example, when a plurality of candidate imaging information exists, for example, the imaging information of the human face or hand gesture in the LED imaging frame, i.e., a target object, the plurality of candidate screening information is screened. For example, the feature obtaining means 102 obtains the distance information between the plurality of candidate imaging information and the target object; the imaging screening means 103 compares the distance information and a predetermined distance threshold; when the distance information is lower than the predetermined distance threshold, then the candidate imaging information is reserved; otherwise, it is deleted so as to implement screening to the plurality of candidate imaging information. Similarly, for other feature information, the above manner may be employed in combination with a predetermined feature threshold to screen the plurality of pieces of candidate imaging information. Preferably, the imaging screening means 103 may screen the plurality of pieces of candidate imaging information in combination with a plurality of pieces of feature information to obtain the imaging information corresponding to the LED.

2) screening the plurality of pieces of candidate imaging information based on a maximum possibility of the feature information to obtain the imaging information corresponding to the LED. Here, the imaging screening means 103 may map each piece of candidate imaging information from a multi-dimensional space in a manner of for example pattern identification, for example, mapping from a space comprising dimensions such as brightness, flickering frequency, wavelength (color), shape, etc., thereby determining the maximum possibility of the feature information of the candidate imaging information. For example, the imaging screening means 103 determines a Gaussian distribution of a brightness value of the candidate imaging information and the covariance of brightness value of each piece of candidate imaging information based on a Gaussian distribution model, thereby obtaining the maximum possibility of the feature information and implementing screening to the candidate imaging information. For example, the imaging screening means 103 obtains based on a great amount of data training that the brightness of the imaging information is 200 with a covariance being 2-3, wherein the brightness value of candidate imaging information 1 is 150, with a covariance being 2, then its possibility is 0.6; the brightness value of candidate imaging information 2 is 200, with a covariance being 1, and then its possibility is 0.7; on this basis, the imaging screening means 103 determines that the maximum possibility of the brightness value is 0.7, and then the candidate imaging information 2 is picked up as the imaging information corresponding to the LED.

3) matching the feature information with a predetermined light spot variation pattern of the light-emitting source so as to obtain corresponding first match information; based on the first match information, screening the plurality of candidate imaging information so as to obtain the imaging information corresponding to the light-emitting source. Specifically, the feature obtaining means 102 detects the light spot variation pattern of the candidate imaging information; the imaging screening means 103 matches the light spot variation pattern with the predetermined light spot variation pattern of the light-emitting source so as to obtain corresponding first match information; for example, if, based on the matching, it is found that a difference between the light spot variation pattern of certain candidate imaging information as detected in real time and the predetermined light spot variation pattern of the emitting means circuit exceeds a threshold, then the imaging screening means 103 deletes the candidate imaging information based on the first match information so as to implement the screening to the plurality of candidate imaging information.

For example, a signal value as obtained based on a bright-dark alternative light spot variation pattern may be used as a particular pattern to perform noise resistance. The specific signal value exhibits a particular light emitting regularity, while a noise in the nature generally has no such light emitting regularity. For example, the signal value 12111211 represents that the light source performs bright-dark flickering at a certain bright time or flickering at a certain bright-dark time interval, or flickering at a certain flickering frequency; when the detected light spot does not have such a flickering feature, it may be regarded as noise to be deleted, thereby implementing the screening to the plurality of candidate imaging information.

4) Based on the feature information and in combination with the background reference information corresponding to the light-emitting source, screening the plurality of candidate imaging information, so as to obtain the imaging information corresponding to the light-emitting source. Specifically, the imaging screening means 103, based on the feature information of the plurality of candidate imaging information as obtained by the feature obtaining means 102, in combination with the background reference information corresponding to the light-emitting source, for example, based on the background reference information obtained based on a plurality of zero input imaging information of the light-emitting source in a zero input state, screens the plurality of candidate imaging information, for example, based on the feature information of a noise point included in the background reference information, judging whether the candidate imaging information includes candidate imaging information similar to the feature information of the noise point, for example, candidate imaging information similar to the noise point in aspects of location, size, color, motion velocity, motion direction, etc., or candidate imaging information similar in a combination of any of the above various features; in the case of comprising, the candidate imaging information is deleted as a noise spot to implement the screening to the plurality of candidate imaging information and obtain the imaging information corresponding to the light-emitting source. Or, the background reference information further comprises the location and motion trend of the noise point, and the imaging screening means 103 identifies the candidate imaging information corresponding to the noise spot among the plurality of candidate imaging information through calculating a predicted location of the noise spot, and then delete the candidate imaging information; or identifies which among the plurality of candidate imaging information are most possibly new, and then saves the candidate imaging information so as to implement screening to the plurality of candidate imaging information.

Preferably, the apparatus 1 further comprises a background obtaining means (not shown). The background obtaining means obtains a plurality of corresponding zero input imaging information of the light-emitting source in the zero input state; performs feature analysis of the plurality of zero input imaging information to obtain the background reference information. Specifically, the light-emitting source may be located in a zero input state that includes, but not limited to, the zero input state explicitly provided by the system in which the method is applied, or is determined based on the corresponding state of a corresponding application as applied by the method, for example, suppose what is applied by the method is a human face detection application, when no human face is detected, it is a zero input state. When the light-emitting source is in a zero input state, the background obtaining means obtains a plurality of corresponding zero input imaging information of the light-emitting source in the zero input state; performs feature analysis to the plurality of zero input imaging information, for example, performing static and dynamic analysis of the plurality of zero input imaging information; the static analysis for example counts the location, size, brightness, color, smooth degree and the like of the zero input imaging information; the dynamic analysis for example counts the motion velocity, motion trace and the like of the zero input imaging information during a continuous detection and may predict the location of the zero input image information in a next frame, etc.; further, based on the feature analysis result, obtains the corresponding background reference information, for example, the location, size, brightness, motion velocity and the like of various noise spots. Here, the statistical recording and tracing on the zero input image information within the view scope as performed by the background obtaining means are all a learning and recording process on the noise feature.

Preferably, the feature obtaining means 102 obtains the feature information of the candidate imaging information based on the imaging analysis of the candidate imaging information, wherein the feature information comprises color distribution information corresponding to the candidate imaging information; wherein the imaging screening means 103 matches the color distribution information corresponding to the candidate imaging information with the predetermined color distribution information so as to obtain corresponding second match information; based on the second match information, screens the plurality of candidate imaging information so as to obtain the imaging information corresponding to the light-emitting source.

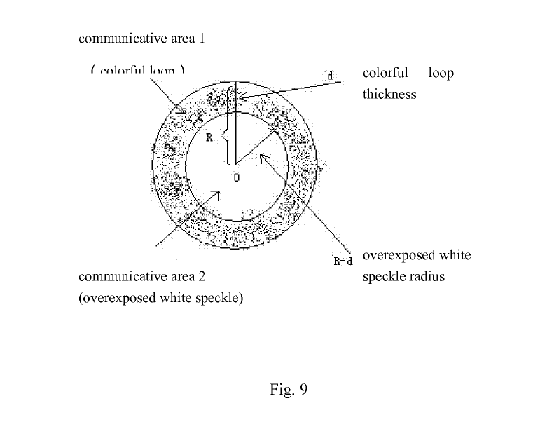

For example, when using a color camera, the imaging information of the color LED on the color camera will generate different color distribution information at different distances, for example, when the emitting means is relatively far away from the color camera, the imaging information corresponding to the color LED will generally assume a common colorful round speckle with a relatively small round speckle radius; while when the emitting means is relatively near to the color camera, the color LED will generally, due to exposure, have a corresponding imaging information assuming a light spot structure with the middle having an overexposure white speckle while the outer periphery having a colorful loop-shaped halo, and at this point, the round speckle has a relatively large round speckle radius. The feature obtaining means 102, through analyzing the candidate imaging information of the color LED or noise spot in the LED imaging frame, obtains corresponding color distribution information. The imaging screening means 103, based on the color distribution information of the candidate imaging information as obtained by the feature obtaining means 102, analyzes whether the color distribution information conforms to a loop structure, i.e., the center is a white round speckle, connected to its peripheral loop colorful area, and the colorful colors should conform to the LED colors. Meanwhile, the imaging screening means 103 may further detect the light spot size of the candidate imaging information and check whether the color distribution information tallies with the light spot size information. During the process of analyzing color distribution information, with a round using the LED center as the center, and R−d as the radius (R denotes the original LED radius, d denotes the empirical threshold of the colorful loop thickness, d<R, as shown in FIG. 9), the LED light speckle is divided into two blocks of to-be-detected communicative areas. The imaging screening means 103, through counting the colors within the two blocks of areas and the color discrepancy degree between the two areas, may distinguish whether the LED is a common color light speckle or a looped light speckle with overexposure white speckle at the center. Thus, the imaging screening means 103 may detect the LED speckle size. When a relatively large light speckle with a looped structure or a relatively small light speckle with a common color light speckle feature is detected, they may be used as eligible imaging information corresponding to the color LED. When a relatively large light speckle with a common color light speckle feature or a relatively small light speckle with a looped light speckle feature is detected, they may be recognized as a noise spot to be deleted so as to implement the screening to the plurality of candidate imaging information.

Preferably, the apparatus 1 further comprises a clustering means (not shown) for clustering the plurality of pieces of candidate imaging information so as to obtain an imaging clustering result, wherein the feature obtaining means 102 extracts a clustering feature corresponding to the imaging clustering result to act as the feature information; next, the imaging screening means 103 screens the plurality of pieces of candidate imaging information based on the feature information, so as to obtain the imaging information corresponding to the LED. Specifically, in the case of a plurality of LEDs, the LED imaging frame comprises a plurality of pieces of imaging information corresponding to the plurality of LEDs; or in the case of a single LED, through reflection or refraction, a plurality of pieces of imaging information are formed in the LED imaging frame; therefore, the plurality of pieces of imaging information and the imaging information corresponding to the noise spot form a plurality of pieces of candidate imaging information. The clustering means clusters the plurality of pieces of candidate imaging information, such that candidate imaging information with similar feature information is clustered, while the candidate imaging information corresponding to other noise spots is relatively discrete; therefore, the feature obtaining means 102 extracts the clustering features corresponding to the imaging clustering results, for example, color (wavelength), brightness, flickering frequency, light emitting pattern, geometrical information, etc.; then, the imaging screening means 103 screens the plurality of pieces of candidate imaging information based on these clustering features, for example, deleting the candidate imaging information whose features are relatively discrete and can hardly be clustered into one class, so as to implement screening to the plurality of pieces of candidate imaging information.

In one implementation, for example candidate imaging information which is close in location may be clustered; and then feature information of each cluster is extracted, for example, color (wavelength) components, brightness components, light emitting pattern, geometrical information, etc., and then based on this feature information, the cluster features (for example, color (wavelength) components, brightness components, light emitting pattern, geometrical information, etc.) that do not conform to the input LED combination are filtered off, such that noise can be effectively removed, and the cluster of cluster features conforming to the input LED combination is taken as the input imaging information. In order to effectively remove noise, the LED combination may comprise LEDs of different colors, different brightness, different light emitting patterns, and different flickering frequencies, which are arranged into a particular spatial geometric structure (for example, assuming a triangle). The LED combinations may be composed of a plurality of LEDs (or radiant bodies), and an LED may also form a plurality of light emitting spots through reflection or transmission using a particular reflection plane or transmission plane.

Those skilled in the art should understand that the above manner of screening candidate imaging information is only exemplary, and other existing manner of screening the candidate imaging information or a manner thereof possibly evolved in the future, if applicable to the present invention, should also be included within the protection scope of the present invention, which are incorporated here by reference.

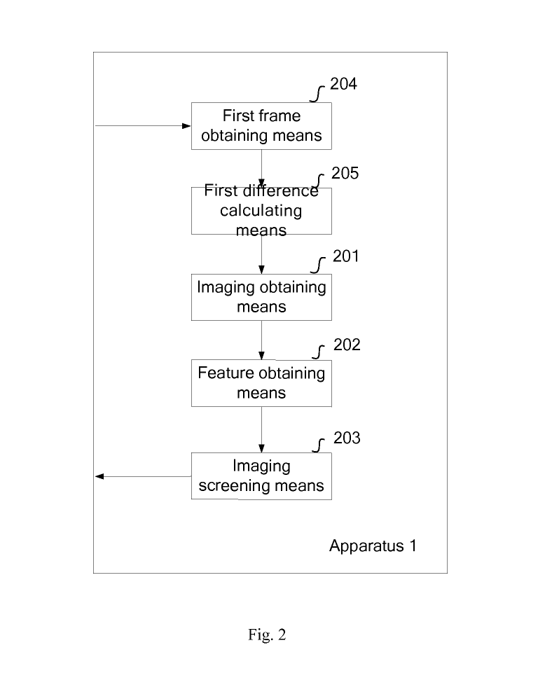

FIG. 2 illustrates a schematic diagram of an apparatus for screening imaging information of a light-emitting source according to one preferred embodiment of the present invention; the apparatus 1 further comprises a first frame obtaining means 204 and a first difference calculating means 205. Hereinafter, the preferred embodiment will be described in detail with reference to FIG. 2: specifically, the first frame obtaining means 204 obtains any two LED imaging frames, wherein the any two LED imaging frames comprise a plurality of pieces of imaging information; the first difference calculating means 205 performs difference calculation to the any two LED imaging frames to obtain an LED difference imaging frame, wherein the LED difference imaging frame comprises difference imaging information; wherein the imaging obtaining means 201 obtains the difference imaging information in the LED difference imaging frame to act as the candidate imaging information; the feature obtaining means 202 obtains feature information of the candidate imaging information; the imaging screening means 203 screens the plurality of pieces of candidate imaging information based on the feature information so as to obtain the imaging information corresponding to the LED. Here, the feature obtaining means 202 and the imaging screening means 203 are identical or substantially identical to the corresponding means in FIG. 1, which are thus not detailed here, but incorporated here by reference.

The first frame obtaining means 204 obtains any two LED imaging frames, wherein the any two LED imaging frames comprise a plurality of pieces of imaging information. Specifically, the first frame obtaining means 204 obtains any two LED imaging frames through performing match query in an imaging base, wherein the any two LED imaging frames comprise a plurality of pieces of imaging information which possibly comprise imaging information corresponding to the LED, and imaging information corresponding to the noise spot. Here, the imaging base stores a plurality of LED imaging frames shot by a camera; the imaging base may be provided in the apparatus 1 or in a third party apparatus connected to the apparatus 1 via a network. Or, the first frame obtaining means 204 obtains imaging frames of LED shot by the camera at two different times, respectively, to act as the any two LED imaging frames.

The first difference calculating means 205 performs difference calculation to the any two LED imaging frames so as to obtain an LED difference imaging frame, wherein the LED difference imaging frame comprises difference imaging information. Specifically, the first difference calculating means 205 performs difference calculation to any two LED imaging frames obtained by the first frame obtaining means 204, for example, minus the brightness at corresponding positions of the any two LED imaging frames to obtain a difference value, with the absolute value of the difference value being taken; further, the absolute value is compared with the threshold value, and imaging information corresponding to an absolute value less than a threshold is deleted, so as to delete the imaging information which is static or with a relative change within a certain range in the any two LED imaging frames, while retaining imaging information having a relative change as difference imaging information. The LED imaging frame obtained through difference calculation acts as the LED difference imaging frame. Here, the relative change means for example the bright-dark change or relative change of the locations of the imaging information in the any two LED imaging frames, etc.

The imaging obtaining means 201 obtains difference imaging information in the LED difference imaging frame through interacting with the first difference calculating means 205 as the candidate imaging information to be available for the imaging screening means 203 to screen based on the feature information.

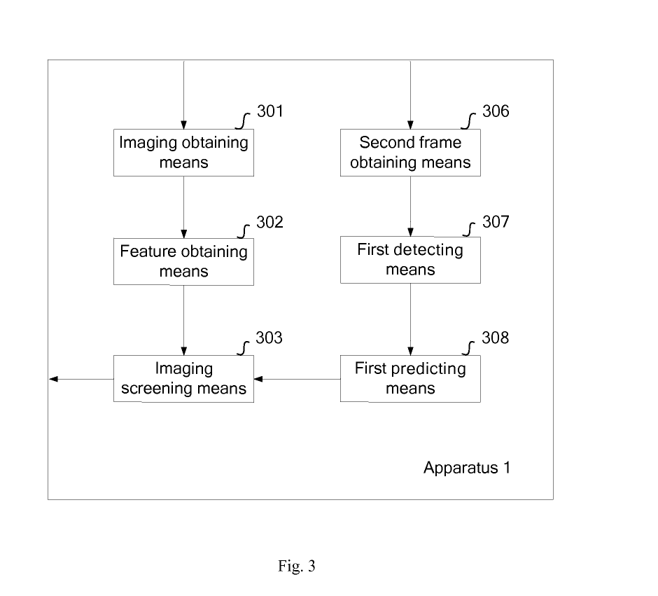

FIG. 3 illustrates a schematic diagram of an apparatus for screening imaging information of a light-emitting source according to one preferred embodiment of the present invention; wherein the LED comprising a moving LED, and the apparatus 1 further comprises a second frame obtaining means 306, a first detecting means 307, and a first predicting means 308. Hereinafter, the preferred embodiment will be described in detail with reference to FIG. 3. Specifically, the second frame obtaining means 306 obtains a consecutive plurality of LED imaging frames before the current LED imaging frame, wherein the consecutive plurality of LED imaging frames all comprise a plurality of pieces of imaging information; the first detecting means 307 detects a moving light spot in the consecutive plurality of LED imaging frames and trace information of the moving light spot; the first predicting means 308 determines predicted location information of the moving light spot in the current LED imaging frame based on the trace information of the moving light spot in combination with the motion model; and imaging obtaining means 301 obtains a plurality of pieces of candidate imaging information in the current LED imaging frame; the feature obtaining means 302 obtains feature information of the candidate imaging information; the imaging screening means 303 screens the plurality of pieces of candidate imaging information based on the feature information in combination with the predicted location information so as to obtain the imaging information corresponding to the LED. Here, the feature obtaining means 302 is identical or substantially identical to the corresponding means in FIG. 1, which is thus not detailed here, but incorporated here by reference.

Here, the second frame obtaining means 306 obtains a consecutive plurality of LED imaging frames before the current LED imaging frame, wherein the consecutive plurality of LED imaging frames all comprise a plurality of pieces of imaging information. Specifically, the second frame obtaining means 306 obtains a consecutive plurality of LED imaging frames before the current LED imaging frame through performing match query in an imaging base, wherein the consecutive plurality of LED imaging frames comprise a plurality of pieces of imaging information which possibly comprise imaging information corresponding to the LED, and imaging information corresponding to the noise spot, etc. Here, the imaging base stores a plurality of LED imaging frames shot by a camera; the plurality of LED imaging frames are consecutive LED imaging frames; the imaging base may be provided in the apparatus 1 or in a third party apparatus connected to the apparatus 1 via a network.

Here, the consecutive plurality of LED imaging frames obtained by the second frame obtaining means 306 may be adjacent to the current LED imaging frame or be spaced from the current LED imaging frame by a certain number of LED imaging frames.

The first detecting means 307 detects a moving light spot in the consecutive plurality of LED imaging frames and trace information of the moving light spot. Specifically, the first detecting means 307 detects whether a moving light spot exists in the consecutive plurality of LED imaging frames through performing difference calculation to the consecutive plurality of LED imaging frames or by adopting a light spot motion tracking algorithm, and when the moving light spot exists, detects the trace information of the moving light spot. With the adoption of light spot motion tracking algorithm as an example, based on the consecutive plurality of LED imaging frames as obtained by the second frame obtaining means 306, the first detecting means 307 detects the imaging information therein one by one frame and obtains the motion trace of the imaging information and calculates the motion features of the imaging information, for example, speed, acceleration, movement distance, etc., and takes the imaging information having the motion features as the moving light spot. Specifically, suppose the currently detected LED imaging frame has imaging information and the imaging information had no detected motion trace, then a new motion trace is generated; the current position of the imaging information is set as the current position of the motion trace, with a start speed being 0 and a variance λ₀ of jitter. At any time t, if there is a detected motion trace, its position at t time is predicted based on its motion feature at t−1 time, for example, its position at t time may be calculated through the following equation:

[Xₜ, Yₜ, Zₜ]=[Xₜ₋₁+VXₜ₋₁*Δt, Yₜ₋₁+VYₜ₋₁*Δt, Zₜ₋₁+VZₜ₋₁*Δt];

wherein VX, VY, VZ denote the motion speeds of the motion trace in X, Y, Z directions, respectively, and these motion speeds may be calculated through the following equation:

[VXₜ, VYₜ, VZₜ]=[(Xₜ−Xₜ₋₁)/Δt, (Yₜ−Yₜ₋₁)/Δt, (Zₜ−Zₜ₋₁)/Δt].

Based on the predicted position, a nearest eligible imaging information is searched in the detected LED imaging frame within the adjacent domain range of the imaging information to act as the new position of the motion trace at time t. Further, the new position is used to update the motion feature of the motion trace. If no eligible imaging information exists, then this motion trace is deleted. The scope of adjacent domain may be determined by the variance λ₀ of the jitter, for example, assuming the domain radius to be twice of λ₀. Assume there is still imaging information that does not belong to any motion trace at time t, then a new motion trace is re-generated; further, the above detecting step is repeated. Here, the present invention may also adopt a more complex light spot motion tracking algorithm, for example, adopting a particle filter manner, to detect a moving light spot in the consecutive plurality of LED imaging frames. Further, difference may be performed to the positions of moving light spots corresponding to adjacent frames on a same motion trace to detect the flickering states and frequencies of the moving light spots. The specific difference method refers to the previously described embodiments. Detection of flickering frequency is to detect the times of bright-dark conversion of the light spot in a unit time on a differential image.

Those skilled in the art should understand that the above manner of detecting a moving light spot is only exemplary, and other existing manner of detecting a moving light spot or a manner thereof possibly evolved in the future, if applicable to the present invention, should also be included within the protection scope of the present invention, which are incorporated here by reference.

The first predicting means 308 determines predicted position information of the moving light spot in the current LED imaging frame based on the trace information of the moving light spot in combination with a motion model. Specifically, the first predicting means 308 determines the predicted position information of the moving light spot in the current LED imaging frame based on the trace information of the moving light spot as detected by the first detecting means 307 in combination with a motion model based on speed or based on acceleration. Here, the motion model includes, but not limited to, a speed-based motion model, an acceleration-based motion model, etc.

With the speed-based motion model as an example, the first predicting means 308 calculates the speed of the moving light spot based on the position information of the moving light spot in consecutive two LED imaging frames before the current LED imaging frame, for example, based on the distance between the two pieces of position information, and the time interval between the consecutive two LED imaging frames. Suppose the light spot moves at a constant speed, further the distance between the position information of the moving light spot in the LED image frame and the position information in the current LED imaging frame is calculated based on the constant speed and the time interval between one LED imaging frame thereof and the current LED imaging frame, and the predicted position information of the moving light spot in the current LED imaging frame is determined based on the position information of the moving light spot in the LED imaging frame. For example, suppose the time interval between two adjacent LED imaging frames is Δt, the LED imaging frame at t time is taken as the current LED imaging frame, the second frame obtaining means 306 obtains two LED imaging frames at t−n time and t−n+1 time, respectively, the speed V=S1/Δt of the moving light spot is calculated based on the distance S1 of the moving light spot between the position information in the two LED imaging frames; further, according to the equation S2=V*nΔt, the distance S2 between the position information of the moving light spot in the LED imaging frame at the t−n time and the position information of the moving light spot in the LED imaging frame at t time is derived; finally, based on the distance S2, the predicted position information of the moving light spot in the LED imaging frame at t time is determined Here, the time interval Δt is determined based on the exposure frequency of the camera.

With the acceleration-based motion model as an example, the LED imaging frame at t time is taken as the current LED imaging frame, the position information of the moving light spot at the current LED imaging frame is denoted as d, the second frame obtaining means 306 obtains three LED imaging frames at time t−3, t−2, and t−1, respectively; the position information of the moving light spot in the three LED imaging frames are denoted as a, b, and c, respectively; the distance between a and b is denoted as S1, the distance between b and c is denoted as S2, and the distance between c and d is denoted as S3; suppose the motion model is based on a constant acceleration, because S1, and S2 are known, then based on the equation S3−S2=S2−S1, the first predicting means 308 may derive S3 through calculation; further, based on the S3 and the position information c, the predicted position information of the moving light spot in the LED imaging frame at t time may be determined.

Those skilled in the art should understand that the above manner of determining predicted position information is only exemplary, and other existing manner of determining predicted position information or a manner thereof possibly evolved in the future, if applicable to the present invention, should also be included within the protection scope of the present invention, which are incorporated here by reference. Those skilled in the art should understand that the above motion model is only exemplary, and other existing motion modes or those possibly evolved in the future, if applicable to the present invention, should also be included within the protection scope of the present invention, which are incorporated here by reference.

The imaging obtaining means 301 obtains a plurality of pieces of candidate imaging information in the current LED imaging frame. Here, the manner for the imaging obtaining means 301 obtains a plurality of pieces of candidate imaging information in the current LED imaging frame is substantially identical to the manner for the corresponding means in the embodiment of FIG. 1, which is thus not detailed here but incorporated here by reference.

The imaging screening means 303 screens the plurality of pieces of candidate imaging information based on the feature information in combination with the predicted position information so as to obtain the imaging information corresponding to the LED. Specifically, the imaging screening means 303, based on the feature information obtained by the feature obtaining means 302, performs preliminary screening to the plurality of pieces of candidate imaging information, for example, through comparing the feature information with a predetermined feature threshold; further, compares the position information of the candidate imaging information as obtained through the preliminary screening with the predicted position information determined by the first predicting means 308, such that when the two pieces of position information conform to each other or their distance offset is within in a certain range, for example within twice of jitter variance (2λ₀), then retains the candidate imaging information; otherwise, deletes the candidate imaging information so as to implement screening to the plurality of pieces of candidate imaging information and obtain the imaging information corresponding to the LED.

More preferably, the apparatus further comprises an updating means (not shown). The updating means updates the motion model based on the trace information in combination with the position information of the candidate imaging information in the current LED imaging frame. Specifically, because the motion trace has jitter variance λ₀, it is hard for the motion model to be based on a constant speed or a constant acceleration, and the predicted position information as determined by the first predicting means 308 has a certain offset from the actual position information. Thus, it is required to update the speed or acceleration in real time based on the trace information of the moving light spot, such that the first predicting means 308 determines more accurately the position in the position information of the moving light post in the LED imaging frame based on the updated speed or acceleration. The first predicting means 308 predicts the predicted position information of the moving light spot in the current LED imaging frame, and searches a nearest eligible imaging information in the current LED imaging frame within an adjacent domain range of the moving light spot (for example 2λ₀) as the position information of the motion trace of the moving light spot at the time based on the predicted position information; further, the updating means re-calculates the motion features corresponding to the motion mode, for example, speed, acceleration, etc., based on the position information so as to perform updating the motion model.

Those skilled in the art should understand that the above manner of updating a motion model is only exemplary, and other existing manner of updating the motion model or manners thereof possibly evolved in the future, if applicable to the present invention, should also be included within the protection scope of the present invention, which are incorporated here by reference.

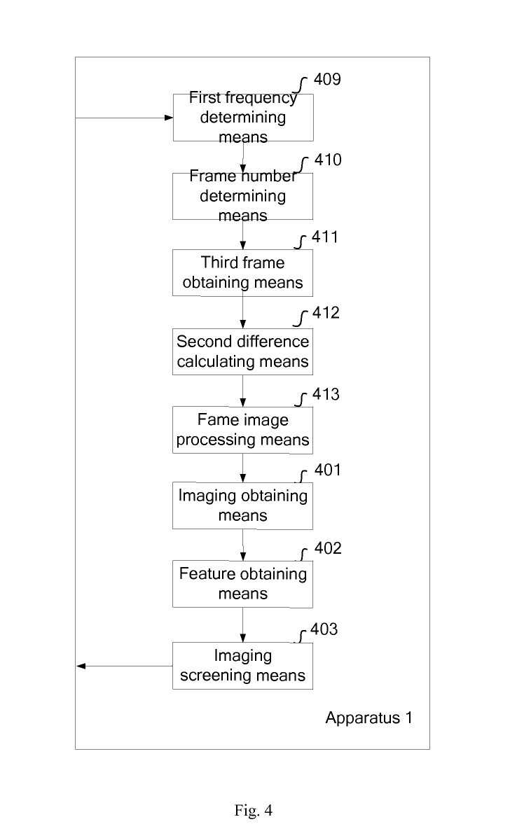

FIG. 4 illustrates a schematic diagram of an apparatus for screening imaging information of a light-emitting source according to one preferred embodiment of the present invention; the apparatus further comprises a first frequency determining means, a frame number determining means 409, a third frame obtaining means 410, a second difference calculating means 411, and a frame image processing means 412. Hereinafter, the preferred embodiment will be described in detail with reference to FIG. 4: specifically, the first frequency determining means determines a flickering frequency of the LED; the frame number determining means 409 determines the number of frames of a consecutive plurality of LED imaging frames to be obtained before the current LED imaging frame based on an exposure frequency of a camera and the flickering frequency of the LED, wherein the exposure frequency of the camera is more than twice of the flickering frequency of the LED; the third frame obtaining means 410 obtains the consecutive plurality of LED imaging frames before the current LED imaging frame based on the number of frames, wherein the current LED imaging frames and the consecutive plurality of LED imaging frames all comprise a plurality of pieces of imaging information; the second difference calculating means 411 performs difference calculation between the consecutive plurality of LED imaging frames and the current LED imaging frame, respectively, to obtain a plurality of LED difference imaging frames; the frame imaging processing means 412 performs fame imaging processing to the plurality of LED difference imaging frames, to obtain frame processing result; the imaging obtaining means 401, based on the frame processing result, screens a plurality of pieces of imaging information in the current LED imaging frame to obtain the candidate imaging information; the feature obtaining means 402 obtains feature information of the candidate imaging information; the imaging screening means 403, based on the feature information, screens the plurality of pieces of candidate imaging information to obtain the imaging information corresponding to the LED. Here, the feature obtaining means 402 and the imaging screening means 403 are identical or substantially identical to the corresponding means in FIG. 1, which are thus not detailed here, but incorporated here by reference.

The first frequency determining means determines the known flickering frequency of the LED through looking up in the database for match or through communication with a transmission means corresponding to the LED.

The frame number determining means 409 determines the number of frames of the consecutive plurality of LED imaging frames to be obtained before the current LED imaging frame based on the exposure frequency of the camera and the flickering frequency of the LED, wherein the exposure frequency of the camera is more than twice of the flickering frequency of the LED. For example, if the exposure frequency of the camera is thrice of the flickering frequency of the LED, then the frame number determining means 409 determines to obtain two consecutive LED imaging frames before the current LED imaging frame. For another example, if the exposure frequency of the camera is four times of the flickering frequency of the LED, then the frame number determining means 409 determines to obtain three consecutive LED imaging frames before the current LED imaging frame. Here, the exposure frequency of the camera is preferably more than twice of the flickering frequency of the LED.

Those skilled in the art should understand that the above manner of determining the frame number is only exemplary, and other existing manner of determining the frame number or a manner thereof possibly evolved in the future, if applicable to the present invention, should also be included within the protection scope of the present invention, which are incorporated here by reference.

The third frame obtaining means 410 obtains a consecutive plurality of LED imaging frames before the current LED imaging frame based on the frame number, wherein the current LED imaging frames and the consecutive plurality of LED imaging frames all comprise a plurality of pieces of imaging information. For example, when the frame number determining means 409 determines to obtain consecutive two LED imaging frames before the current LED imaging frame, then the third frame obtaining means 410 obtains two consecutive LED imaging frames before the current LED imaging frame through looking up in the imaging base for match, wherein the consecutive two LED imaging frames comprise a plurality of pieces of imaging information which might comprise the imaging information corresponding to the LED and the imaging information corresponding to the noise spot, etc. Here, the imaging base stores a plurality of LED imaging frames shot by a camera; the plurality of LED imaging frames are consecutive LED imaging frames; the imaging base may be provided in the apparatus 1 or in a third party apparatus connected to the apparatus 1 via a network.

The second difference calculating means 411 performs difference calculation between the consecutive plurality of LED imaging frames and the current LED imaging frame, respectively, to obtain a plurality of LED difference imaging frames. Specifically, the second difference calculating means 411 performs difference calculation between the consecutive two LED imaging frames and the current LED imaging frame, respectively, to obtain two LED difference imaging frames. Here, the operation performed by the second difference calculating means 411 is substantially identical to the operation performed by the first difference calculating means 205 in the embodiment of FIG. 2, which is thus not detailed here, but incorporated herein by reference.

The frame image processing 412 performs frame image processing to the plurality of LED difference imaging frame to obtain frame processing result. Specifically, the manner for the frame image processing means 412 to obtain the frame processing result includes, but not limited to:

1) performing threshold binarization to imaging information in the plurality of LED difference imaging frames, respectively, to generate a plurality of candidate binarization images; merging the plurality of candidate binarization images to obtain the frame processing result. For example a threshold value is preset; each pixel spot in the plurality of LED difference imaging frames is compared with the threshold value, respectively; if it exceeds the threshold value, it is valued as 0, which represents the pixel spot has color information, i.e., the pixel spot has imaging information; if it is lower than the threshold value, it is valued as 1, which represents that the pixel spot has no color information, i.e., the pixel spot has no imaging information. The frame image processing means 412 generates a candidate binarization image based on a result obtained after the above threshold binarization; one LED difference imaging frame corresponds to a candidate binarization image; next, the plurality of candidate binarization images are subjected to merge processing, for example, the plurality of candidate binarization images are subjected to union set processing to obtain a merged binarization image as the frame processing result.

2) merging the plurality of LED difference imaging frames to obtain a merged LED difference imaging frame; the merged LED difference imaging frame is subjected to frame image processing to obtain the frame processing result. Here, the frame image processing includes, but not limited, to filtering based on a binarization result, round detection, brightness, shape, and position, etc. For example, the frame image processing means 412 takes the largest value from the absolute values corresponding to respective pixel spots based on the absolute values of the difference values of the pixel spots in the plurality of LED difference imaging frames; next, the largest value is subjected to an operation such as binarization, and the result of binarization acts as the frame processing result.

Those skilled in the art should understand that the above manner of frame image processing is only exemplary, and other existing manner of frame image processing or a manner thereof possibly evolved in the future, if applicable to the present invention, should also be included within the protection scope of the present invention, which are incorporated here by reference.

Next, the imaging obtaining means 401 screens a plurality of pieces of imaging information in the current LED imaging frame based on the frame processing result, so as to obtain the candidate imaging information. For example, suppose the frame processing result is a binarization image, then the imaging obtaining means 401 retains the imaging information corresponding to the binarization image while deleting the remaining imaging information based on the plurality of pieces of imaging information in the current LED imaging frame, so as to perform screening to the plurality of pieces of imaging information and takes the imaging information retained after the screening as the candidate imaging information to be available for the imaging screening means 403 to further screen based on the feature information.

Preferably, the feature obtaining means 402 determines a flickering frequency of the candidate imaging information based on imaging analysis of the candidate imaging information in combination with the frame processing result; wherein the imaging screening means 403 screens the plurality of pieces of candidate imaging information based on the flickering frequency of the candidate imaging information in combination with the flickering frequency of the LED, so as to obtain the imaging information corresponding to the LED. For example, the feature obtaining means 402 detects a flickering light spot in the LED imaging frame based on the frame processing result to act as the candidate imaging information, and derive the bright-dark change of the LED based on the plurality of LED difference imaging frames, and further derives the flickering frequency of the flickering light spot, i.e., the candidate imaging information, based on the bright-dark change; next, the imaging screening means 403 compares the flickering frequency of the candidate imaging information with the flickering frequency of the LED, such that when the two flickering frequencies are consistent or have little difference, the candidate imaging information is retained; otherwise, it is deleted, thereby implementing screening to the plurality of pieces of candidate imaging information to obtain imaging information corresponding to the LED.

Preferably, when the light-emitting source comprises a moving light-emitting source, the apparatus 1 further comprises a second frequency determining means (not shown), a fourth frame obtaining means (not shown), a third difference calculating means (no t shown), and the second detecting means (not shown),

Wherein the second frequency determining means determines that the exposure frequency of the camera is more than twice of the flickering frequency of the light-emitting source.

The fourth frame obtaining means obtains a consecutive plurality of imaging frames, wherein the consecutive plurality of imaging frames all comprise a plurality of pieces of imaging information. Here, the operation performed by the fourth frame obtaining means is identical or substantially identical to the operation of obtaining an imaging frame in the previously described embodiments, which is thus not detailed here, but incorporated herein by reference.

The third difference calculating means performs difference calculation to every two adjacent imaging frames in the consecutive plurality of imaging frames, so as to obtain difference imaging information. Here, the operation performed by the third difference calculating means is identical or substantially identical to the operation of performing difference calculation to imaging frames in the previously described embodiments, which is thus not detailed here, but incorporated herein by reference.

The second detecting means detects a moving light spot in the consecutive plurality of LED imaging frames and trace information of the moving light spot. Here, the operation performed by the second detecting means is identical or substantially identical to the operations of detecting a moving light spot and trace information in the previously described embodiments, which is thus not detailed here, but incorporated herein by reference.

The imaging obtaining means 401 takes the moving light spot as the candidate imaging information.

The feature obtaining means 402 determines a flickering frequency of the candidate imaging information based on the trace information of the moving light spot in combination with the difference imaging information. For example, when the flickering frequency of the LED and the exposure frequency of the camera are both relatively low, for examples, tens of hundreds of times, the feature obtaining means 402 records the case in which it is impossible to detect a light spot for other frame in the middle within a corresponding predicted position range of the motion trace as flickering based on the moving light spot detected by the second detecting means, i.e., the motion trace of the candidate imaging information, in combination with the bright-dark change of the moving light spot as obtained by the third difference calculating means, so as to calculate the flickering frequency of the motion trace and record it as the flickering frequency of the candidate imaging information.

The imaging screening means 403 screens the plurality of pieces of candidate imaging information based on the flickering frequency of the candidate imaging information in combination with the flickering frequency of the light-emitting source, so as to obtain the imaging information corresponding to the light-emitting source. For example, the imaging screening means 403, based on a comparison between the flickering frequency of the candidate imaging information and the flickering frequency of the LED, retains the candidate imaging information when the two flickering frequencies are identical or have little difference; otherwise, deletes the candidate imaging information, so as to implement screening to the plurality of pieces of candidate imaging information and obtain the imaging information corresponding to the LED.

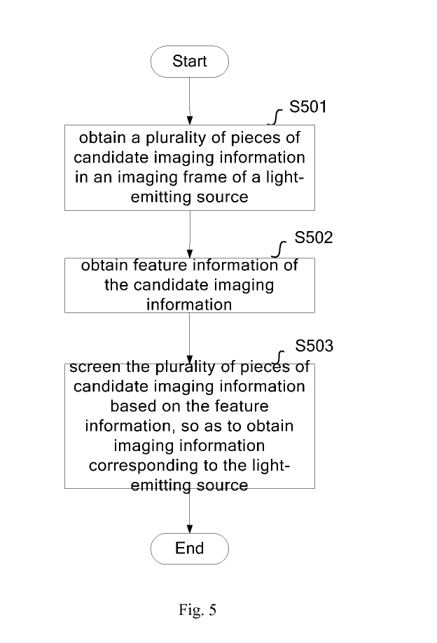

FIG. 5 illustrates a flow chart of a method of screening imaging information of a light-emitting source according to another aspect of the present invention.

In this embodiment, in step S501, the apparatus 1 obtains a plurality of pieces of candidate imaging information in an imaging frame of the light-emitting source. Specifically, in step S501, the apparatus 1 obtains a plurality of pieces of candidate imaging information in an imaging frame of a light-emitting source through performing a match query in an imaging base, or obtains the imaging information obtained by the apparatus 1 after the other operation steps as the candidate imaging information; or, obtains an imaging frame of the light-emitting source as shot by a camera, and obtains a plurality of pieces of candidate imaging information in an imaging frame of the light-emitting source through performing image analysis on the imaging frame of the light-emitting source. Here, the light-emitting source includes, but not limited, to a spot light source, a plane light source, a ball light source, or any other light source that emits light at a certain light emitting frequency, for example, an LED visible light source, an LED infrared light source, an OLED (Organic Light Emitting Diode) light source, and a laser light source, etc. A plurality of pieces of candidate imaging information in the imaging frame includes one or more pieces of imaging information corresponding to one or more light-emitting sources, as well as imaging information corresponding to a noise point such as a cigarette butt or other lamp light.

Here, the imaging base stores a great amount of imaging frames corresponding to the light-emitting source, as well as candidate imaging information in the great amount of imaging frames; the imaging base may be provided in the apparatus 1 or a third party apparatus connected to the apparatus 1 via a network.

Those skilled in the art should understand that the above manner of obtaining imaging information is only exemplary, and other existing manner of obtaining imaging information or a manner possibly evolved in the future, if applicable to the present invention, should also be included within the protection scope of the present invention, which are incorporated here by reference.

The following embodiments will only take an LED as example. Those skilled in the art should understand that other existing light-emitting sources or those possibly evolved in the future, particularly, an OLED, if applicable to the present invention, should also be included within the protection scope of the present invention, which are incorporated here by reference. Here, the LED (Light Emitting Diode) is a solid semiconductor device capable of converting electrical energy into visible light. It may directly converting electricity into light and takes the light as a control signal.

in step S502, the apparatus 1 obtains feature information of the candidate imaging information. Specifically, in step S502, the apparatus 1 obtains feature information of the plurality of pieces of candidate imaging information through interaction with for example a feature information base. Here, the feature information base stores feature information of the candidate imaging information and establishes or updates the feature information base according to analysis on the candidate imaging information in a new imaging frame as shot by a camera for each time. Or, preferably, in step S502, the apparatus 1 determines the feature information of the candidate imaging information based on an imaging analysis on the candidate imaging information, wherein the feature information comprises at least one of the following items:
wavelength information of a light source corresponding to the candidate imaging information;
flickering frequency corresponding to the candidate imaging information;
brightness information corresponding to the candidate imaging information;
light emitting pattern corresponding to the candidate imaging information;
geometrical information corresponding to the candidate imaging information;
distance information between the light source corresponding to the candidate imaging information and the camera.
color distribution information corresponding to the candidate imaging information.

Specifically, in step S502, the apparatus 1 obtains feature information of the candidate imaging information based on a plurality of pieces of candidate imaging information in an LED imaging frame as obtained in step S501 through performing imaging analysis on the plurality of pieces of candidate imaging information, for example, performing image processing such as image digitalization and Hough-transformation to the LED imaging frame.

Here, as a light source corresponding to the candidate imaging information, the LED or noise point has a certain wavelength and may form a light with a color corresponding to the wavelength; in step S502, the apparatus 1 obtains the wavelength information of the light source corresponding to the candidate imaging information through for example detecting and analyzing the (R, G, B) value or (H, S, V) value of a pixel point in the LED imaging frame.

For another example, when the LED or noise point emits light at a certain flickering frequency, for example, flickers 10 times per second, in step S502, the apparatus 1 may determine, through detecting a plurality of LED imaging frames, based on the bright-dark variation of the candidate imaging information in each LED imaging frame, the flickering frequency corresponding to the candidate imaging information. Here, the flickering may also comprises emitting light with different brightness in alternation, instead of emitting light merely in a bright-and-dark pattern.

When the LED or noise spot emits light with a certain brightness (here, the brightness indicates a luminous flux of the LED or noise spot at a unit solid angle unit area in a particular direction), in step S502, the apparatus 1 determines the brightness information corresponding to the candidate imaging information, for example through calculating an average or sum of gray values of the plurality of pieces of candidate imaging information in the LED imaging frame; or, determines through a brightness value of an optical pixel spot in the LED imaging frame.

When the LED or noise spot emits light with a certain light emitting pattern, for example, emitting light with a pattern in which the fringe is bright and the center is dark, in step S502, the apparatus 1 may determine a light emitting pattern corresponding to the candidate imaging information through detecting and analyzing the (R, G, B) value, (H, S, V) value or brightness value of each pixel spot in the LED imaging frame.

Here, the light emitting pattern includes, but not limited to, shape, wavelength, flickering frequency, brightness or brightness distribution, etc.

When the LED or noise spot emits light with a certain geometrical shape, for example, the LED emits light in shapes such as triangle, round, or square, or a plurality of LEDs combine to form a light emitting pattern of a certain shape, in step S502, the apparatus 1, through detecting and analyzing each pixel spot in the LED imaging frame, determines geometrical information corresponding to the candidate imaging information, such as area, shape, relative location between a plurality of pieces of imaging information, a pattern formed by the plurality of pieces of imaging information, etc.

For another example, as a light source corresponding to candidate imaging information, the distance between the LED or noise spot and the camera is different; in step S502, the apparatus 1 obtains corresponding information such as radius, brightness, and the like through analyzing the candidate imaging information of the LED or noise spot in the LED imaging frame, and further calculates the distance information between the LED or noise spot and the camera based on the above information.

For a further example, the candidate imaging information corresponding to the LED or noise spot in the LED imaging frame might have corresponding color distribution information. For example, when using a color camera, the imaging information of the color LED on the color camera will generate different color distribution information at different distances. For example, when the emitting means is relatively far from the color camera, the imaging information corresponding to the color LED will generally assume a common colorful round speckle with a relatively small round speckle radius; while when the emitting means is relatively near to the color camera, the color LED will generally, due to exposure, have a corresponding imaging information assuming a light spot structure with the middle having an overexposure white speckle while the outer periphery having a colorful loop-shaped halo, and at this point, the round speckle has a relatively large round speckle radius. In step S502, the apparatus 1 obtains the corresponding color distribution information through analyzing the corresponding candidate imaging information of the color LED or noise spot in the LED imaging frame.

Preferably, in step S502, the apparatus 1 obtains the feature information of the candidate imaging information based on the imaging analysis of the candidate imaging information, wherein the feature information comprises distance information of the candidate imaging information away from the target object. For example, for a human face or hand gesture, and the like, they likewise have corresponding imaging information in the LED imaging frame, and with such imaging information as a target object, in step S502, the apparatus 1 analyzes the corresponding candidate imaging information of the LED or noise spot in the LED imaging frame, and then calculates to obtain the distance information of the candidate imaging information away from the target object based on the information.

Preferably, in step S502, the apparatus 1 obtains the feature information of the candidate imaging information based on the imaging analysis of the candidate imaging information, wherein the feature information comprises a light spot variation pattern corresponding to the candidate imaging information, the light spot variation pattern includes, but not limited to, bright-dark alternative variation, wavelength alternative variation, light spot geometrical feature variation, flicker frequency alternative variation, brightness distribution alternative variation, etc.; the light spot geometrical feature variation for example comprises light spot number variation, geometrical shape variation, or a variation combining the above two variations.

Specifically, the light-emitting source has a predetermined light spot variation pattern. For example, through programming the emitting means circuit, different voltages or currents or different current paths are generated, to drive one or more boarded LEDs to generate various kinds of light spot feature variation occurring in alternation. These controllable light spot features include for example, brightness, light emitting shape, light emitting wavelength (for example, color), light emitting area, etc. The generated light spot variation pattern may be an alternative periodic variation of one light spot feature or a combined regular alternative variation of a plurality of light spot features.

With the light spot variation pattern with bright-dark alternative variation as an example, the light spot variation pattern with bright-dark alternative variation includes, but not limited to:

1) With bright or dark of the light-emitting source within a predefined duration as a signal value, the minimum duration time of the bright or dark is at least no lower than the exposure time of the camera unit; preferably, the minimum duration time of the bright or dark is no lower than a sum of the exposure time of the camera unit and the interval between two exposure times.

For example, with bright or dark of the light-emitting source within a predefined duration as a signal value, for example, a continuous bright of 10 ms has a value 1, while a continuous dark of 10 ms has a value 0, then the signal value of 20 ms continuous bright and 10 ms continuous dark is 110. Here, the minimum duration of bright or dark is at least no lower than the exposure time of the camera unit. Preferably, the minimum duration time of bright or dark is no lower than the sum of the exposure time of the camera unit and the interval between two exposure times.

2) With the interval between two bright-dark alternation times of the light-emitting source as the signal value, wherein the minimum time interval between two times of bright-dark alternations is at least twice of the exposure time of the camera unit; preferably, the minimum time interval between two times of bright-dark alternations is at least twice of the sum of the exposure time of the camera unit and the interval between two exposures.

For example, with the time interval between two times of bright-dark alternations of the light-emitting source, i.e., the flickering time interval, as the signal value, for example, the 10 ms time interval between two times of flickers has a signal value 1, and the 20 ms time interval between two times of flickers has a signal value 2; then when the time interval between the first and second flickers is 10 ms and the time interval between the second and third flickers is 20 ms, the generated signal value is 12. Here, the minimum time interval between two times of bright-dark alterations, i.e., the flickering time interval, should be at least twice of the exposure time of the camera unit. Preferably, the minimum time interval between two times of bright-dark alterations is at least twice of the sum of the exposure time of the camera unit and the time interval between two exposures.

3) With the bright-dark alterative frequency of the light-emitting source as the signal value, the exposure frequency of the camera unit is at least twice of the bright-dark alterative frequency, wherein the exposure frequency refers to the exposure times of the camera unit within a unit time.

For example, with the bright-dark alterative frequency of the light-emitting source, i.e., the flicker frequency, as the signal value, if the signal value for occurrence of flicker once within 1 s is 1, and twice is 2, then when one flicker occurs within the 1st second and two flickers occur within the 2nd second, the generated signal value is 12. Here, the exposure frequency of the camera unit is at least twice of the bright-dark alternative frequency.

For another example, the light spot variation pattern may comprise a flickering frequency alternative variation. Through performing programming control to the LED control circuit, flickering frequency of the LED light spot may be controlled, and alternative variation is performed based on different flickering frequency. For example, the light spot flickers 10 times in the first second and flickers 20 times in the second second, and so forth to perform the alternative variations. The flickering frequency with a regular alternative variation is used as a specific light spot variation pattern and further as feature information for screening imaging information.

For another example, the light spot variation pattern may further comprise a brightness distribution alternative variation. Through performing programming control to the LED control circuit, brightness distribution of the LED light spot may be controlled, and alternative variation is performed based on different brightness distributions. For example, the light spot assumes a brightness distribution with light in the center while dark in the periphery within the first second and a brightness distribution with dark in the middle and light in the periphery within the second second, and so forth to perform the alternative variations; for another example, the alternative variation is performed with a brightness distribution where the central light speckle has a radius R1 within the first second, and a brightness distribution where the central light speckle of the light spot has a radius R2 within the second second, and so forth to perform the alternative variations. These brightness distributions with a regular alternative variation are used as a specific light spot variation pattern and further as feature information for screening imaging information.

Preferably, the light-emitting source may further send the control signal with reference to the above arbitrary plurality of predetermined light spot variation patterns, for example, sending the control signal with the light spot variation pattern with bright-dark alternative variation plus wavelength alternative variation. With the LED as an example, the LED, for example, emits light with the light spot variation pattern with red-green plus bright-dark alternation.

More preferably, the light-emitting source may also use a light spot variation pattern of a combination of multiple different wavelengths (colors) to send a control signal, and its alternation may be embodied as alternating with combinations of different colors. Here, a combination of different wavelengths (colors) may form a light-emitting unit through a dual-color LED or more than two LEDs having different wavelengths (colors). More preferably, the light-emitting source may send a control signal using a plurality of different wavelengths (colors) in conjunction with a light spot variation pattern of the bright-dark alternative variation and the light-spot geometrical feature variation. For example, at any time, different light-emitting color distributions may be formed by merely lighting one LED thereby or by lighting the two LEDs simultaneously; or one LED lights constantly, while the other flickers at a certain frequency, thereby achieving a light-spot variation pattern with different color combinations.

Preferably, noise-resistance may be realized in case of sending a control signal by adopting an alternative light-spot variation pattern in which one LED lights constantly while the other flickers at a certain frequency. For example, this light emitting pattern first uses two LED light-emitting spots to screen off a noise spot of individual light-emitting spots in the natural world; this light emitting pattern then uses an LED light-emitting spot with a particular color distribution to screen off those noise spots that are not of the particular color in the natural world; further, the light emitting pattern screens off other noise spots which are not in the light emitting pattern by one LED constantly lighting and the other LED flickering at a certain frequency.

Those skilled in the art should understand that the above feature information and manners of obtaining the feature information is only exemplary, and other existing feature information or manner of obtaining the feature information or the feature information and the manner of obtaining the feature information possibly evolved in the future, if applicable to the present invention, should also be included within the protection scope of the present invention, which are incorporated here by reference.

In step S503, the apparatus 1 screens the plurality of pieces of candidate imaging information based on the feature information so as to obtain the imaging information corresponding to the LED. Specifically, the manners in which in step S503 screens the plurality of pieces of candidate imaging information include, but not limited to:

1) screening the plurality of pieces of candidate imaging information based on the feature information obtained in step S502 in combination with a predetermined feature threshold, so as to obtain the imaging information corresponding to the LED. For example, the feature information as obtained in step S502 comprises brightness information of the plurality of pieces of candidate imaging information; in step S503, the apparatus 1 compares the brightness information with a predetermined brightness threshold, for example, comparing with a predetermined LED light spot brightness threshold; if the brightness information is within the scope of the brightness threshold, the candidate imaging information is reserved; otherwise, it is deleted so as to implement screening to the plurality of pieces of candidate imaging information and finally obtain the imaging information corresponding to the LED. For another example, when a plurality of candidate imaging information exists, for example, the imaging information of the human face or hand gesture in the LED imaging frame, i.e., a target object, the plurality of candidate screening information is screened. For example, in step S502, the apparatus 1 obtains the distance information between the plurality of candidate imaging information and the target object; in step S503, the apparatus 1 compares the distance information and a predetermined distance threshold; when the distance information is lower than the predetermined distance threshold, then the candidate imaging information is reserved; otherwise, it is deleted so as to implement screening to the plurality of candidate imaging information. Similarly, for other feature information, the above manner may be employed in combination with a predetermined feature threshold to screen the plurality of pieces of candidate imaging information. Preferably, in step S503, the apparatus 1 may screen the plurality of pieces of candidate imaging information in combination with a plurality of pieces of feature information to obtain the imaging information corresponding to the LED.

2) screening the plurality of pieces of candidate imaging information based on a maximum possibility of the feature information to obtain the imaging information corresponding to the LED. Here, in step S503, the apparatus 1 may map each piece of candidate imaging information from a multi-dimensional space in a manner of for example pattern identification, for example, mapping from a space comprising dimensions such as brightness, flickering frequency, wavelength (color), shape, etc., thereby determining the maximum possibility of the feature information of the candidate imaging information. For example, in step S503, the apparatus 1 determines a Gaussian distribution of a brightness value of the candidate imaging information and the covariance of brightness value of each piece of candidate imaging information based on a Gaussian distribution model, thereby obtaining the maximum possibility of the feature information and implementing screening to the candidate imaging information. For example, in step S503, the apparatus 1 obtains based on a great amount of data training that the brightness of the imaging information is 200 with a covariance being 2-3, wherein the brightness value of candidate imaging information 1 is 150, with a covariance being 2, then its possibility is 0.6; the brightness value of candidate imaging information 2 is 200, with a covariance being 1, and then its possibility is 0.7; on this basis, in step S503, the apparatus 1 determines that the maximum possibility of the brightness value is 0.7, and then the candidate imaging information 2 is picked up as the imaging information corresponding to the LED.

3) matching the feature information with a predetermined light spot variation pattern of the light-emitting source so as to obtain corresponding first match information; based on the first match information, screening the plurality of candidate imaging information so as to obtain the imaging information corresponding to the light-emitting source. Specifically, in step S502, the apparatus 1 detects the light spot variation pattern of the candidate imaging information; in step S503, the apparatus 1 matches the light spot variation pattern with the predetermined light spot variation pattern of the light-emitting source so as to obtain corresponding first match information; for example, if, based on the matching, it is found that a difference between the light spot variation pattern of certain candidate imaging information as detected in real time and the predetermined light spot variation pattern of the emitting means circuit exceeds a threshold, then in step S503, the apparatus 1 deletes the candidate imaging information based on the first match information so as to implement the screening to the plurality of candidate imaging information.

For example, a signal value as obtained based on a bright-dark alternative light spot variation pattern may be used as a particular pattern to perform noise resistance. The specific signal value exhibits a particular light emitting regularity, while a noise in the nature generally has no such light emitting regularity. For example, the signal value 12111211 represents that the light source performs bright-dark flickering at a certain bright time or flickering at a certain bright-dark time interval, or flickering at a certain flickering frequency; when the detected light spot does not have such a flickering feature, it may be regarded as noise to be deleted, thereby implementing the screening to the plurality of candidate imaging information.

4) Based on the feature information and in combination with the background reference information corresponding to the light-emitting source, screening the plurality of candidate imaging information, so as to obtain the imaging information corresponding to the light-emitting source. Specifically, in step S503, the apparatus 1, based on the feature information of the plurality of candidate imaging information as obtained in step S502, in combination with the background reference information corresponding to the light-emitting source, for example, based on the background reference information obtained based on a plurality of zero input imaging information of the light-emitting source in a zero input state, screens the plurality of candidate imaging information, for example, based on the feature information of a noise point included in the background reference information, judging whether the candidate imaging information includes candidate imaging information similar to the feature information of the noise point, for example, candidate imaging information similar to the noise point in aspects of location, size, color, motion velocity, motion direction, etc., or candidate imaging information similar in a combination of any of the above various features; in the case of comprising, the candidate imaging information is deleted as a noise spot to implement the screening to the plurality of candidate imaging information and obtain the imaging information corresponding to the light-emitting source. Or, the background reference information further comprises the location and motion trend of the noise point, and in step S503, the apparatus 1 identifies the candidate imaging information corresponding to the noise spot among the plurality of candidate imaging information through calculating a predicted location of the noise spot, and then delete the candidate imaging information; or identifies which among the plurality of candidate imaging information are most possibly new, and then saves the candidate imaging information so as to implement screening to the plurality of candidate imaging information.

Preferably, the method further comprises step S520 (not shown). In step S520, the apparatus 1 obtains a plurality of corresponding zero input imaging information of the light-emitting source in the zero input state; performs feature analysis of the plurality of zero input imaging information to obtain the background reference information. Specifically, the light-emitting source may be located in a zero input state that includes, but not limited to, the zero input state explicitly provided by the system in which the method is applied, or is determined based on the corresponding state of a corresponding application as applied by the method, for example, suppose what is applied by the method is a human face detection application, when no human face is detected, it is a zero input state. When the light-emitting source is in a zero input state, in step S520, the apparatus 1 obtains a plurality of corresponding zero input imaging information of the light-emitting source in the zero input state; performs feature analysis to the plurality of zero input imaging information, for example, performing static and dynamic analysis of the plurality of zero input imaging information; the static analysis for example counts the location, size, brightness, color, smooth degree and the like of the zero input imaging information; the dynamic analysis for example counts the motion velocity, motion trace and the like of the zero input imaging information during a continuous detection and may predict the location of the zero input image information in a next frame, etc.; further, based on the feature analysis result, obtains the corresponding background reference information, for example, the location, size, brightness, motion velocity and the like of various noise spots. Here, the statistical recording and tracing on the zero input image information within the view scope as performed in step S520 are all a learning and recording process on the noise feature.

Preferably, in step S502, the apparatus 1 obtains the feature information of the candidate imaging information based on the imaging analysis of the candidate imaging information, wherein the feature information comprises color distribution information corresponding to the candidate imaging information; wherein in step S503, the apparatus 1 matches the color distribution information corresponding to the candidate imaging information with the predetermined color distribution information so as to obtain corresponding second match information; based on the second match information, screens the plurality of candidate imaging information so as to obtain the imaging information corresponding to the light-emitting source.

For example, when using a color camera, the imaging information of the color LED on the color camera will generate different color distribution information at different distances, for example, when the emitting means is relatively far away from the color camera, the imaging information corresponding to the color LED will generally assume a common colorful round speckle with a relatively small round speckle radius; while when the emitting means is relatively near to the color camera, the color LED will generally, due to exposure, have a corresponding imaging information assuming a light spot structure with the middle having an overexposure white speckle while the outer periphery having a colorful loop-shaped halo, and at this point, the round speckle has a relatively large round speckle radius. In step S503, the apparatus 1, through analyzing the candidate imaging information of the color LED or noise spot in the LED imaging frame, obtains corresponding color distribution information. In step S503, the apparatus 1, based on the color distribution information of the candidate imaging information as obtained in step S502, analyzes whether the color distribution information conforms to a loop structure, i.e., the center is a white round speckle, connected to its peripheral loop colorful area, and the colorful colors should conform to the LED colors. Meanwhile, in step S503, the apparatus 1 may further detect the light spot size of the candidate imaging information and check whether the color distribution information tallies with the light spot size information. During the process of analyzing color distribution information, with a round using the LED center as the center, and R−d as the radius (R denotes the original LED radius, d denotes the empirical threshold of the colorful loop thickness, d<R, as shown in FIG. 9), the LED light speckle is divided into two blocks of to-be-detected communicative areas. In step S503, the apparatus 1, through counting the colors within the two blocks of areas and the color discrepancy degree between the two areas, may distinguish whether the LED is a common color light speckle or a looped light speckle with overexposure white speckle at the center. Thus, in step S503, the apparatus 1 may detect the LED speckle size. When a relatively large light speckle with a looped structure or a relatively small light speckle with a common color light speckle feature is detected, they may be used as eligible imaging information corresponding to the color LED. When a relatively large light speckle with a common color light speckle feature or a relatively small light speckle with a looped light speckle feature is detected, they may be recognized as a noise spot to be deleted so as to implement the screening to the plurality of candidate imaging information.

Preferably, in step S514 (not shown), the apparatus 1 clusters the plurality of pieces of candidate imaging information so as to obtain an imaging clustering result, wherein in step S502, the apparatus 1 extracts a clustering feature corresponding to the imaging clustering result to act as the feature information; next, in step S503, the apparatus 1 screens the plurality of pieces of candidate imaging information based on the feature information, so as to obtain the imaging information corresponding to the LED. Specifically, in the case of a plurality of LEDs, the LED imaging frame comprises a plurality of pieces of imaging information corresponding to the plurality of LEDs; or in the case of a single LED, through reflection or refraction, a plurality of pieces of imaging information are formed in the LED imaging frame; therefore, the plurality of pieces of imaging information and the imaging information corresponding to the noise spot form a plurality of pieces of candidate imaging information. In step S514, the apparatus 1 clusters the plurality of pieces of candidate imaging information, such that candidate imaging information with similar feature information is clustered, while the candidate imaging information corresponding to other noise spots is relatively discrete; therefore, in step S502, the apparatus 1 extracts the clustering features corresponding to the imaging clustering results, for example, color (wavelength), brightness, flickering frequency, light emitting pattern, geometrical information, etc.; then, in step S503, the apparatus 1 screens the plurality of pieces of candidate imaging information based on these clustering features, for example, deleting the candidate imaging information whose features are relatively discrete and can hardly be clustered into one class, so as to implement screening to the plurality of pieces of candidate imaging information.

In one implementation, for example candidate imaging information which is close in location may be clustered; and then feature information of each cluster is extracted, for example, color (wavelength) components, brightness components, light emitting pattern, geometrical information, etc., and then based on this feature information, the cluster features (for example, color (wavelength) components, brightness components, light emitting pattern, geometrical information, etc.) that do not conform to the input LED combination are filtered off, such that noise can be effectively removed, and the cluster of cluster features conforming to the input LED combination is taken as the input imaging information. In order to effectively remove noise, the LED combination may comprise LEDs of different colors, different brightness, different light emitting patterns, and different flickering frequencies, which are arranged into a particular spatial geometric structure (for example, assuming a triangle). The LED combinations may be composed of a plurality of LEDs (or radiant bodies), and an LED may also form a plurality of light emitting spots through reflection or transmission using a particular reflection plane or transmission plane.

Those skilled in the art should understand that the above manner of screening candidate imaging information is only exemplary, and other existing manner of screening the candidate imaging information or a manner thereof possibly evolved in the future, if applicable to the present invention, should also be included within the protection scope of the present invention, which are incorporated here by reference.

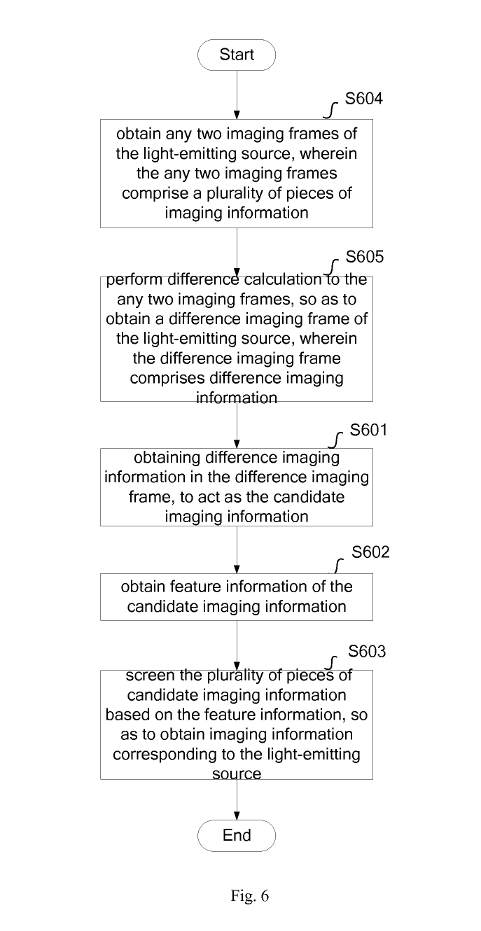

FIG. 6 illustrates a flow chart of a method of screening imaging information of a light-emitting source according to one preferred embodiment of the present invention. Hereinafter, the preferred embodiment will be described in detail with reference to FIG. 6: specifically, in step S604, the apparatus 1 obtains any two LED imaging frames, wherein the any two LED imaging frames comprise a plurality of pieces of imaging information; in step S605, the apparatus 1 performs difference calculation to the any two LED imaging frames to obtain an LED difference imaging frame, wherein the LED difference imaging frame comprises difference imaging information; wherein in step S601, the apparatus 1 obtains the difference imaging information in the LED difference imaging frame to act as the candidate imaging information; in step S602, the apparatus 1 obtains feature information of the candidate imaging information; in step S603, the apparatus 1 screens the plurality of pieces of candidate imaging information based on the feature information so as to obtain the imaging information corresponding to the LED. Here, the step 602 and S603 are identical or substantially identical to the corresponding steps in FIG. 5, which are thus not detailed here, but incorporated here by reference.

In step S604, the apparatus 1 obtains any two LED imaging frames, wherein the any two LED imaging frames comprise a plurality of pieces of imaging information. Specifically, in step S604, the apparatus 1 obtains any two LED imaging frames through performing match query in an imaging base, wherein the any two LED imaging frames comprise a plurality of pieces of imaging information which possibly comprise imaging information corresponding to the LED, and imaging information corresponding to the noise spot. Here, the imaging base stores a plurality of LED imaging frames shot by a camera; the imaging base may be provided in the apparatus 1 or in a third party apparatus connected to the apparatus 1 via a network. Or, in step S604, the apparatus 1 obtains imaging frames of LED shot by the camera at two different times, respectively, to act as the any two LED imaging frames.

In step S605, the apparatus 1 performs difference calculation to the any two LED imaging frames so as to obtain an LED difference imaging frame, wherein the LED difference imaging frame comprises difference imaging information. Specifically, in step S605, the apparatus 1 performs difference calculation to any two LED imaging frames obtained in step S604, for example, minus the brightness at corresponding positions of the any two LED imaging frames to obtain a difference value, with the absolute value of the difference value being taken; further, the absolute value is compared with the threshold value, and imaging information corresponding to an absolute value less than a threshold is deleted, so as to delete the imaging information which is static or with a relative change within a certain range in the any two LED imaging frames, while retaining imaging information having a relative change as difference imaging information. The LED imaging frame obtained through difference calculation acts as the LED difference imaging frame. Here, the relative change means for example the bright-dark change or relative change of the locations of the imaging information in the any two LED imaging frames, etc.

In step S601, the apparatus 1 obtains difference imaging information in the LED difference imaging frame as the candidate imaging information to be available for the apparatus 1 to screen based on the feature information in the following steps.

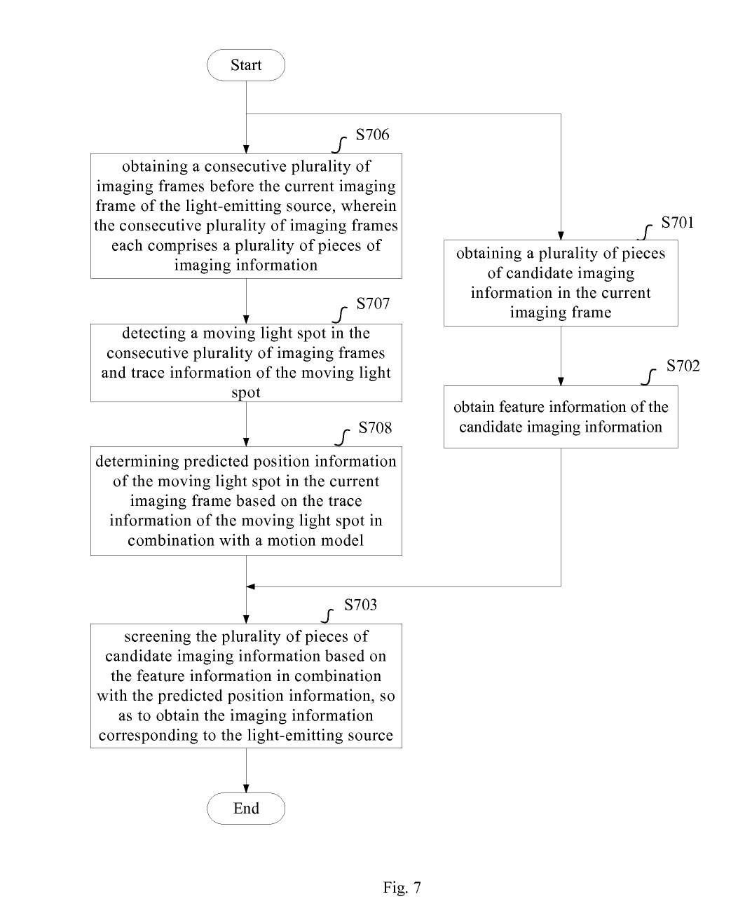

FIG. 7 illustrates a flow chart of a method of screening imaging information of a light-emitting source according to another preferred embodiment of the present invention. Wherein, the LED comprises a moving LED. Hereinafter, the preferred embodiment will be described in detail with reference to FIG. 7. Specifically, in step S706, the apparatus 1 obtains a consecutive plurality of LED imaging frames before the current LED imaging frame, wherein the consecutive plurality of LED imaging frames all comprise a plurality of pieces of imaging information; in step S707, the apparatus 1 detects a moving light spot in the consecutive plurality of LED imaging frames and trace information of the moving light spot; in step S708, the apparatus 1 determines predicted location information of the moving light spot in the current LED imaging frame based on the trace information of the moving light spot in combination with the motion model; and in step S701, the apparatus 1 obtains a plurality of pieces of candidate imaging information in the current LED imaging frame; in step S702, the apparatus 1 obtains feature information of the candidate imaging information; in step S703, the apparatus 1 screens the plurality of pieces of candidate imaging information based on the feature information in combination with the predicted location information so as to obtain the imaging information corresponding to the LED. Here, the step S702 is identical or substantially identical to the corresponding step in FIG. 5, which is thus not detailed here, but incorporated here by reference.

Here, in step S706, the apparatus 1 obtains a consecutive plurality of LED imaging frames before the current LED imaging frame, wherein the consecutive plurality of LED imaging frames all comprise a plurality of pieces of imaging information. Specifically, in step S706, the apparatus 1 obtains a consecutive plurality of LED imaging frames before the current LED imaging frame through performing match query in an imaging base, wherein the consecutive plurality of LED imaging frames comprise a plurality of pieces of imaging information which possibly comprise imaging information corresponding to the LED, and imaging information corresponding to the noise spot, etc. Here, the imaging base stores a plurality of LED imaging frames shot by a camera; the plurality of LED imaging frames are consecutive LED imaging frames; the imaging base may be provided in the apparatus 1 or in a third party apparatus connected to the apparatus 1 via a network.

Here, the consecutive plurality of LED imaging frames obtained in step S706 may be adjacent to the current LED imaging frame or be spaced from the current LED imaging frame by a certain number of LED imaging frames.

In step S707, the apparatus 1 detects a moving light spot in the consecutive plurality of LED imaging frames and trace information of the moving light spot. Specifically, in step S707, the apparatus 1 detects whether a moving light spot exists in the consecutive plurality of LED imaging frames through performing difference calculation to the consecutive plurality of LED imaging frames or by adopting a light spot motion tracking algorithm, and when the moving light spot exists, detects the trace information of the moving light spot. With the adoption of light spot motion tracking algorithm as an example, based on the consecutive plurality of LED imaging frames as obtained in step S706, in step S707, the apparatus 1 detects the imaging information therein one by one frame and obtains the motion trace of the imaging information and calculates the motion features of the imaging information, for example, speed, acceleration, movement distance, etc., and takes the imaging information having the motion features as the moving light spot. Specifically, suppose the currently detected LED imaging frame has imaging information and the imaging information had no detected motion trace, then a new motion trace is generated; the current position of the imaging information is set as the current position of the motion trace, with a start speed being 0 and a variance λ₀ of jitter. At any time t, if there is a detected motion trace, its position at t time is predicted based on its motion feature at t−1 time, for example, its position at t time may be calculated through the following equation:

[Xₜ, Yₜ, Zₜ]=[Xₜ₋₁+VXₜ₋₁*Δt, Yₜ₋₁+VYₜ₋₁*Δt, Zₜ₋₁+VZₜ₋₁*Δt];

wherein VX, VY, VZ denote the motion speeds of the motion trace in X, Y, Z directions, respectively, and these motion speeds may be calculated through the following equation:

[VXₜ, VYₜ, VZₜ]=[(Xₜ−Xₜ₋₁)/Δt, (Yₜ−Yₜ₋₁)/Δt, (Zₜ−Zₜ₋₁)/Δt].

Based on the predicted position, a nearest eligible imaging information is searched in the detected LED imaging frame within the adjacent domain range of the imaging information to act as the new position of the motion trace at time t. Further, the new position is used to update the motion feature of the motion trace. If no eligible imaging information exists, then this motion trace is deleted. The scope of adjacent domain may be determined by the variance λ₀ of the jitter, for example, assuming the domain radius to be twice of λ₀. Assume there is still imaging information that does not belong to any motion trace at time t, then a new motion trace is re-generated; further, the above detecting step is repeated. Here, the present invention may also adopt a more complex light spot motion tracking algorithm, for example, adopting a particle filter manner, to detect a moving light spot in the consecutive plurality of LED imaging frames. Further, difference may be performed to the positions of moving light spots corresponding to adjacent frames on a same motion trace to detect the flickering states and frequencies of the moving light spots. The specific difference method refers to the previously described embodiments. Detection of flickering frequency is to detect the times of bright-dark conversion of the light spot in a unit time on a differential image.

Those skilled in the art should understand that the above manner of detecting a moving light spot is only exemplary, and other existing manner of detecting a moving light spot or a manner thereof possibly evolved in the future, if applicable to the present invention, should also be included within the protection scope of the present invention, which are incorporated here by reference.

In step S708, the apparatus 1 determines predicted position information of the moving light spot in the current LED imaging frame based on the trace information of the moving light spot in combination with a motion model. Specifically, in step S708, the apparatus 1 determines the predicted position information of the moving light spot in the current LED imaging frame based on the trace information of the moving light spot as detected in step S707 in combination with a motion model based on speed or based on acceleration. Here, the motion model includes, but not limited to, a speed-based motion model, an acceleration-based motion model, etc.

With the speed-based motion model as an example, in step S708, the apparatus 1 calculates the speed of the moving light spot based on the position information of the moving light spot in consecutive two LED imaging frames before the current LED imaging frame, for example, based on the distance between the two pieces of position information, and the time interval between the consecutive two LED imaging frames. Suppose the light spot moves at a constant speed, further the distance between the position information of the moving light spot in the LED image frame and the position information in the current LED imaging frame is calculated based on the constant speed and the time interval between one LED imaging frame thereof and the current LED imaging frame, and the predicted position information of the moving light spot in the current LED imaging frame is determined based on the position information of the moving light spot in the LED imaging frame. For example, suppose the time interval between two adjacent LED imaging frames is At, the LED imaging frame at t time is taken as the current LED imaging frame, in step S706, the apparatus 1 obtains two LED imaging frames at t−n time and t−n+1 time, respectively, the speed V=S1/Δt of the moving light spot is calculated based on the distance S1 of the moving light spot between the position information in the two LED imaging frames; further, according to the equation S2=V*nΔt, the distance S2 between the position information of the moving light spot in the LED imaging frame at the t−n time and the position information of the moving light spot in the LED imaging frame at t time is derived; finally, based on the distance S2, the predicted position information of the moving light spot in the LED imaging frame at t time is determined. Here, the time interval Δt is determined based on the exposure frequency of the camera.

With the acceleration-based motion model as an example, the LED imaging frame at t time is taken as the current LED imaging frame, the position information of the moving light spot at the current LED imaging frame is denoted as d, in step S706, the apparatus 1 obtains three LED imaging frames at time t−3, t−2, and t−1, respectively; the position information of the moving light spot in the three LED imaging frames are denoted as a, b, and c, respectively; the distance between a and b is denoted as S1, the distance between b and c is denoted as S2, and the distance between c and d is denoted as S3; suppose the motion model is based on a constant acceleration, because S1, and S2 are known, then based on the equation S3−S2=S2−S1, in step S708, the apparatus 1 may derive S3 through calculation; further, based on the S3 and the position information c, the predicted position information of the moving light spot in the LED imaging frame at t time may be determined.

Those skilled in the art should understand that the above manner of determining predicted position information is only exemplary, and other existing manner of determining predicted position information or a manner thereof possibly evolved in the future, if applicable to the present invention, should also be included within the protection scope of the present invention, which are incorporated here by reference. Those skilled in the art should understand that the above motion model is only exemplary, and other existing motion modes or those possibly evolved in the future, if applicable to the present invention, should also be included within the protection scope of the present invention, which are incorporated here by reference.

In step S701, the apparatus 1 obtains a plurality of pieces of candidate imaging information in the current LED imaging frame. Here, the manner for the apparatus 1 obtains a plurality of pieces of candidate imaging information in the current LED imaging frame in step S706 is substantially identical to the manner for the corresponding steps in the embodiment of FIG. 5, which is thus not detailed here but incorporated here by reference.

In step S703, the apparatus 1 screens the plurality of pieces of candidate imaging information based on the feature information in combination with the predicted position information so as to obtain the imaging information corresponding to the LED. Specifically, in step S706, the apparatus 1, based on the feature information obtained in step S702, performs preliminary screening to the plurality of pieces of candidate imaging information, for example, through comparing the feature information with a predetermined feature threshold; further, compares the position information of the candidate imaging information as obtained through the preliminary screening with the predicted position information determined in step S708, such that when the two pieces of position information conform to each other or their distance offset is within in a certain range, for example within twice of jitter variance (2λ₀), then retains the candidate imaging information; otherwise, deletes the candidate imaging information so as to implement screening to the plurality of pieces of candidate imaging information and obtain the imaging information corresponding to the LED.

More preferably, in step S715 (not shown), the apparatus updates the motion model based on the trace information in combination with the position information of the candidate imaging information in the current LED imaging frame. Specifically, because the motion trace has jitter variance λ₀, it is hard for the motion model to be based on a constant speed or a constant acceleration, and the predicted position information as determined in step S708 has a certain offset from the actual position information. Thus, it is required to update the speed or acceleration in real time based on the trace information of the moving light spot, such that the apparatus 1 determines more accurately the position in the position information of the moving light post in the LED imaging frame based on the updated speed or acceleration. In step S708, the apparatus 1 predicts the predicted position information of the moving light spot in the current LED imaging frame, and searches a nearest eligible imaging information in the current LED imaging frame within an adjacent domain range of the moving light spot (for example 2λ₀) as the position information of the motion trace of the moving light spot at the time based on the predicted position information; further, in step S715, the apparatus 1 re-calculates the motion features corresponding to the motion mode, for example, speed, acceleration, etc., based on the position information so as to perform updating the motion model.

Those skilled in the art should understand that the above manner of updating a motion model is only exemplary, and other existing manner of updating the motion model or manners thereof possibly evolved in the future, if applicable to the present invention, should also be included within the protection scope of the present invention, which are incorporated here by reference.

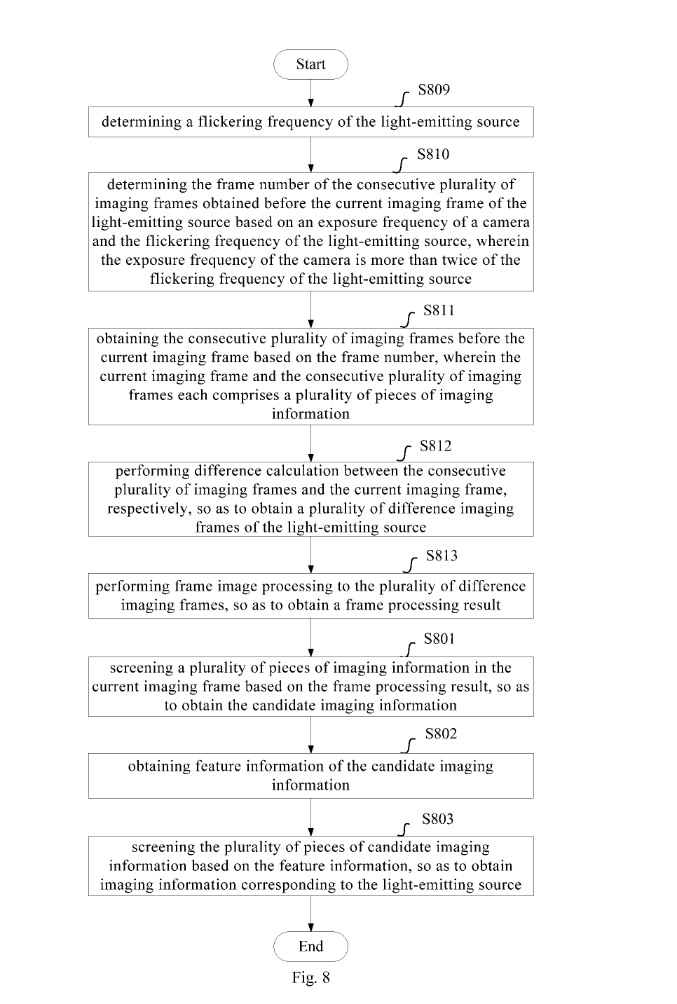

FIG. 8 illustrates a flow chart of a method of screening imaging information of a light-emitting source according to one further preferred embodiment of the present invention. Hereinafter, the preferred embodiment will be described in detail with reference to FIG. 8: specifically, in step S809, the apparatus 1 determines a flickering frequency of the LED; in step S810, the apparatus 1 determines the number of frames of a consecutive plurality of LED imaging frames to be obtained before the current LED imaging frame based on an exposure frequency of a camera and the flickering frequency of the LED, wherein the exposure frequency of the camera is more than twice of the flickering frequency of the LED; in step S811, the apparatus 1 obtains the consecutive plurality of LED imaging frames before the current LED imaging frame based on the number of frames, wherein the current LED imaging frames and the consecutive plurality of LED imaging frames all comprise a plurality of pieces of imaging information; in step S812, the apparatus 1 performs difference calculation between the consecutive plurality of LED imaging frames and the current LED imaging frame, respectively, to obtain a plurality of LED difference imaging frames; in step S813, the apparatus 1 performs fame imaging processing to the plurality of LED difference imaging frames, to obtain frame processing result; in step S801, the apparatus 1, based on the frame processing result, screens a plurality of pieces of imaging information in the current LED imaging frame to obtain the candidate imaging information; in step S802, the apparatus 1 obtains feature information of the candidate imaging information; in step S803, the apparatus 1, based on the feature information, screens the plurality of pieces of candidate imaging information to obtain the imaging information corresponding to the LED. Here, the step S802 and S803 are identical or substantially identical to the corresponding steps in FIG. 5, which are thus not detailed here, but incorporated here by reference.

In step S809, the apparatus 1 determines the known flickering frequency of the LED through looking up in the database for match or through communication with a transmission means corresponding to the LED.

In step S810, the apparatus 1 determines the number of frames of the consecutive plurality of LED imaging frames to be obtained before the current LED imaging frame based on the exposure frequency of the camera and the flickering frequency of the LED, wherein the exposure frequency of the camera is more than twice of the flickering frequency of the LED. For example, if the exposure frequency of the camera is thrice of the flickering frequency of the LED, then in step S810, the apparatus 1 determines to obtain two consecutive LED imaging frames before the current LED imaging frame. For another example, if the exposure frequency of the camera is four times of the flickering frequency of the LED, then in step S810, the apparatus 1 determines to obtain three consecutive LED imaging frames before the current LED imaging frame. Here, the exposure frequency of the camera is preferably more than twice of the flickering frequency of the LED.

Those skilled in the art should understand that the above manner of determining the frame number is only exemplary, and other existing manner of determining the frame number or a manner thereof possibly evolved in the future, if applicable to the present invention, should also be included within the protection scope of the present invention, which are incorporated here by reference.

In step S811, the apparatus 1 obtains a consecutive plurality of LED imaging frames before the current LED imaging frame based on the frame number, wherein the current

LED imaging frames and the consecutive plurality of LED imaging frames all comprise a plurality of pieces of imaging information. For example, when in step S810, the apparatus 1 determines to obtain consecutive two LED imaging frames before the current LED imaging frame, then in step S811, the apparatus 1 obtains two consecutive LED imaging frames before the current LED imaging frame through looking up in the imaging base for match, wherein the consecutive two LED imaging frames comprise a plurality of pieces of imaging information which might comprise the imaging information corresponding to the LED and the imaging information corresponding to the noise spot, etc. Here, the imaging base stores a plurality of LED imaging frames shot by a camera; the plurality of LED imaging frames are consecutive LED imaging frames; the imaging base may be provided in the apparatus 1 or in a third party apparatus connected to the apparatus 1 via a network.

In step S812, the apparatus 1 performs difference calculation between the consecutive plurality of LED imaging frames and the current LED imaging frame, respectively, to obtain a plurality of LED difference imaging frames. Specifically, in step S812, the apparatus 1 performs difference calculation between the consecutive two LED imaging frames and the current LED imaging frame, respectively, to obtain two LED difference imaging frames. Here, the operation performed by the apparatus 1 in step S809 is substantially identical to the operation performed by the apparatus 1 in step S605 in the embodiment of FIG. 6, which is thus not detailed here, but incorporated herein by reference.

In step S813, the apparatus 1 performs frame image processing to the plurality of LED difference imaging frame to obtain frame processing result. Specifically, the manner for the apparatus 1 to obtain the frame processing result in step S809 includes, but not limited to:

1) performing threshold binarization to imaging information in the plurality of LED difference imaging frames, respectively, to generate a plurality of candidate binarization images; merging the plurality of candidate binarization images to obtain the frame processing result. For example a threshold value is preset; each pixel spot in the plurality of LED difference imaging frames is compared with the threshold value, respectively; if it exceeds the threshold value, it is valued as 0, which represents the pixel spot has color information, i.e., the pixel spot has imaging information; if it is lower than the threshold value, it is valued as 1, which represents that the pixel spot has no color information, i.e., the pixel spot has no imaging information. In step S813, the apparatus 1 generates a candidate binarization image based on a result obtained after the above threshold binarization; one LED difference imaging frame corresponds to a candidate binarization image; next, the plurality of candidate binarization images are subjected to merge processing, for example, the plurality of candidate binarization images are subjected to union set processing to obtain a merged binarization image as the frame processing result.

2) merging the plurality of LED difference imaging frames to obtain a merged LED difference imaging frame; the merged LED difference imaging frame is subjected to frame image processing to obtain the frame processing result. Here, the frame image processing includes, but not limited, to filtering based on a binarization result, round detection, brightness, shape, and position, etc. For example, in step S813, the apparatus 1 takes the largest value from the absolute values corresponding to respective pixel spots based on the absolute values of the difference values of the pixel spots in the plurality of LED difference imaging frames; next, the largest value is subjected to an operation such as binarization, and the result of binarization acts as the frame processing result.

Those skilled in the art should understand that the above manner of frame image processing is only exemplary, and other existing manner of frame image processing or a manner thereof possibly evolved in the future, if applicable to the present invention, should also be included within the protection scope of the present invention, which are incorporated here by reference.

Next, in step S801, the apparatus 1 screens a plurality of pieces of imaging information in the current LED imaging frame based on the frame processing result, so as to obtain the candidate imaging information. For example, suppose the frame processing result is a binarization image, then in step S801, the apparatus 1 retains the imaging information corresponding to the binarization image while deleting the remaining imaging information based on the plurality of pieces of imaging information in the current LED imaging frame, so as to perform screening to the plurality of pieces of imaging information and takes the imaging information retained after the screening as the candidate imaging information to be available for the apparatus 1 to further screen in step S803 based on the feature information.

Preferably, in step S802, the apparatus 1 determines a flickering frequency of the candidate imaging information based on imaging analysis of the candidate imaging information in combination with the frame processing result; wherein in step S803, the apparatus 1 screens the plurality of pieces of candidate imaging information based on the flickering frequency of the candidate imaging information in combination with the flickering frequency of the LED, so as to obtain the imaging information corresponding to the LED. For example, in step S802, the apparatus 1 detects a flickering light spot in the LED imaging frame based on the frame processing result to act as the candidate imaging information, and derive the bright-dark change of the LED based on the plurality of LED difference imaging frames, and further derives the flickering frequency of the flickering light spot, i.e., the candidate imaging information, based on the bright-dark change; next, in step S803, the apparatus 1 compares the flickering frequency of the candidate imaging information with the flickering frequency of the LED, such that when the two flickering frequencies are consistent or have little difference, the candidate imaging information is retained; otherwise, it is deleted, thereby implementing screening to the plurality of pieces of candidate imaging information to obtain imaging information corresponding to the LED.

Preferably, when the light-emitting source comprises a moving light-emitting source, in step S816 (not shown), the apparatus 1 determines that the exposure frequency of the camera is more than twice of the flickering frequency of the light-emitting source.

In step S817 (not shown), the apparatus 1 obtains a consecutive plurality of imaging frames, wherein the consecutive plurality of imaging frames all comprise a plurality of pieces of imaging information. Here, the operation performed by the apparatus 1 in step S817 is identical or substantially identical to the operation of obtaining an imaging frame in the previously described embodiments, which is thus not detailed here, but incorporated herein by reference.

In step S818 (not shown), the apparatus 1 performs difference calculation to every two adjacent imaging frames in the consecutive plurality of imaging frames, so as to obtain difference imaging information. Here, the operation performed by the apparatus 1 in step S818 is identical or substantially identical to the operation of performing difference calculation to imaging frames in the previously described embodiments, which is thus not detailed here, but incorporated herein by reference.

In step S819 (not shown), the apparatus 1 detects a moving light spot in the consecutive plurality of LED imaging frames and trace information of the moving light spot. Here, the operation performed by the apparatus 1 in step S819 is identical or substantially identical to the operations of detecting a moving light spot and trace information in the previously described embodiments, which is thus not detailed here, but incorporated herein by reference.

In step S801, the apparatus 1 takes the moving light spot as the candidate imaging information.

In step S802, the apparatus 1 determines a flickering frequency of the candidate imaging information based on the trace information of the moving light spot in combination with the difference imaging information. For example, when the flickering frequency of the LED and the exposure frequency of the camera are both relatively low, for examples, tens of hundreds of times, in step S802, the apparatus 1 records the case in which it is impossible to detect a light spot for other frame in the middle within a corresponding predicted position range of the motion trace as flickering based on the moving light spot detected by the second detecting means, i.e., the motion trace of the candidate imaging information, in combination with the bright-dark change of the moving light spot as obtained by the third difference calculating means, so as to calculate the flickering frequency of the motion trace and record it as the flickering frequency of the candidate imaging information.

In step S803, the apparatus 1 screens the plurality of pieces of candidate imaging information based on the flickering frequency of the candidate imaging information in combination with the flickering frequency of the light-emitting source, so as to obtain the imaging information corresponding to the light-emitting source. For example, in step S803, the apparatus 1, based on a comparison between the flickering frequency of the candidate imaging information and the flickering frequency of the LED, retains the candidate imaging information when the two flickering frequencies are identical or have little difference; otherwise, deletes the candidate imaging information, so as to implement screening to the plurality of pieces of candidate imaging information and obtain the imaging information corresponding to the LED.

To those skilled in the art, it is apparent that the present invention is not limited to the details of above exemplary embodiments, and the present invention can be implemented with other specific embodiments without departing the spirit or basic features of the present invention. Thus, from any perspective, the embodiments should be regarded as illustrative and non-limiting. The scope of the present invention is limited by the appended claims, instead of the above description. Thus, meanings of equivalent elements falling within the claims and all variations within the scope are intended to be included within the present invention. Any reference numerals in the claims should be regarded as limiting the involved claims. Besides, it is apparent that such terms as “comprise” and “include” do not exclude other units or steps, and a single form does not exclude a plural form. The multiple units or modules as stated in apparatus claims can also be implemented by a single unit or module through software or hardware. Terms such as first and second are used to represent names, not representing any specific sequence.

1. A method of screening imaging information of a light-emitting source, wherein the method comprises:
a. obtaining a plurality of pieces of candidate imaging information in an imaging frame of a light-emitting source;
b. obtaining feature information of the candidate imaging information;
c. screening the plurality of pieces of candidate imaging information based on the feature information, so as to obtain imaging information corresponding to the light-emitting source.

2. The method according to claim 1, wherein the step c comprises:
screening the plurality of pieces of candidate imaging information based on the feature information in combination with a predetermined feature threshold, so as to obtain the imaging information corresponding to the light-emitting source.

3. The method according to claim 1, wherein the step c comprises:
screening the plurality of pieces of candidate imaging information based on a maximum possibility of the feature information, so as to obtain the imaging information corresponding to the light-emitting source.

4. The method according to claim 1, wherein the feature information comprises a light spot variation pattern, wherein the step b comprises:
detecting a light spot variation pattern of the candidate imaging information;
wherein, the step c comprises:
matching the light spot variation pattern with a predetermined light spot variation pattern of the light-emitting source so as to obtain corresponding first match information;
based on the first matching information, screening the plurality of pieces of candidate imaging information so as to obtain the imaging information corresponding to the light-emitting source.

5. The method according to claim 4, wherein the light spot variation pattern comprises at least one of the following items:
bright-dark alternative variation;
wavelength alternative variation
light spot geometrical feature variation;
flicker frequency alternative variation;
brightness distribution alternative variation.

6. The method according to claim 1, wherein the step c comprises:
screening the plurality of pieces of candidate imaging information based on the feature information in combination with background reference information corresponding to the light-emitting source, so as to obtain imaging information corresponding to the light-emitting source.

7. The method according to claim 6, wherein the method further comprises:
obtaining a plurality of pieces of zero input imaging information corresponding to the light-emitting source in a zero input state;
performing feature analysis of the plurality of pieces of zero input imaging information to obtain the background reference information.

8. The method according to claim 1, wherein the method further comprises:
clustering the plurality of pieces of candidate imaging information, so as to obtain an imaging clustering result;
wherein, the step b comprises:
extracting a clustering feature corresponding to the imaging clustering result, to act as the feature information.

9. The method according to claim 1, wherein the step b comprises:
obtaining the feature information of the candidate imaging information based on imaging analysis of the candidate imaging information;
wherein the feature information comprises at least one of the following items:
wavelength information of a light source corresponding to the candidate imaging information;
flickering frequency corresponding to the candidate imaging information;
brightness information corresponding to the candidate imaging information;
light emitting pattern corresponding to the candidate imaging information;
geometrical information corresponding to the candidate imaging information;
distance information between the light source corresponding to the candidate imaging information and the camera;
color distribution information corresponding to the candidate imaging information.

10. The method according to claim 1, wherein the step b comprises:
obtaining the feature information of the candidate imaging information based on imaging analysis of the candidate imaging information, wherein the feature information comprises wavelength information and/or flickering frequency of a light source corresponding to the candidate imaging information.

11. The method according to claim 1, wherein the step b comprises:
obtaining the feature information of the candidate imaging information based on imaging analysis of the candidate imaging information, wherein the feature information comprises a light emitting pattern corresponding to the candidate imaging information.

12. The method according to claim 1, wherein the step b comprises:
obtaining the feature information of the candidate imaging information based on imaging analysis of the candidate imaging information, wherein the feature information comprises geometrical information corresponding to the candidate imaging information.

13. The method according to claim 1, wherein the step b comprises:
obtaining feature information of the candidate imaging information based on the imaging analysis of the candidate imaging information, wherein the feature information comprises distance information between the candidate imaging information and a target object.

14. The method according to claim 1, wherein the step b comprises:
obtaining feature information of the candidate imaging information based on imaging analysis of the candidate imaging information, wherein the feature information comprises color distribution information corresponding to the candidate imaging information;
wherein, the step c comprises:
matching the color distribution information corresponding to the candidate imaging information with a predetermined color distribution information so as to obtain corresponding second match information;
based on the second match information, screening the plurality of pieces of candidate imaging information so as to obtain imaging information corresponding to the light-emitting source.

15. The method according to claim 1, wherein the method further comprises:
obtaining any two imaging frames of the light-emitting source, wherein the any two imaging frames comprises a plurality of pieces of imaging information;
performing difference calculation to the any two imaging frames, so as to obtain a difference imaging frame of the light-emitting source, wherein the difference imaging frame comprises difference imaging information;
wherein, the step a comprises:
obtaining difference imaging information in the difference imaging frame, to act as the candidate imaging information.

16. The method according to claim 1, wherein the light-emitting source comprises a moving light-emitting source, wherein the method further comprises:
obtaining a consecutive plurality of imaging frames before the current imaging frame of the light-emitting source, wherein the consecutive plurality of imaging frames each comprises a plurality of pieces of imaging information;
detecting a moving light spot in the consecutive plurality of imaging frames and trace information of the moving light spot;
determining predicted position information of the moving light spot in the current imaging frame based on the trace information of the moving light spot in combination with a motion model;
wherein, the step a comprises:
obtaining a plurality of pieces of candidate imaging information in the current imaging frame;
wherein, the step c comprises:
screening the plurality of pieces of candidate imaging information based on the feature information in combination with the predicted position information, so as to obtain the imaging information corresponding to the light-emitting source.

17. The method according to claim 16, wherein the motion model comprises at least one of the following items:
speed-based motion model;
acceleration-based motion model.

18. The method according to claim 16, wherein the method further comprises:
updating the motion model based on the trace information in combination with position information of the candidate imaging information in the current imaging frame.

19. The method according to claim 1, wherein the method further comprises:
determining a flickering frequency of the light-emitting source;
determining the frame number of the consecutive plurality of imaging frames obtained before the current imaging frame of the light-emitting source based on an exposure frequency of a camera and the flickering frequency of the light-emitting source, wherein the exposure frequency of the camera is more than twice of the flickering frequency of the light-emitting source;
obtaining the consecutive plurality of imaging frames before the current imaging frame based on the frame number, wherein the current imaging frame and the consecutive plurality of imaging frames each comprises a plurality of pieces of imaging information;
performing difference calculation between the consecutive plurality of imaging frames and the current imaging frame, respectively, so as to obtain a plurality of difference imaging frames of the light-emitting source;
x performing frame image processing to the plurality of difference imaging frames, so as to obtain a frame processing result;
wherein, the step a comprises:
screening a plurality of pieces of imaging information in the current imaging frame based on the frame processing result, so as to obtain the candidate imaging information.

20. The method according to claim 19, wherein the step b comprises:
determining a flickering frequency of the candidate imaging information based on imaging analysis of the candidate imaging information in combination with the frame processing result;
wherein, the step c comprises:
screening the plurality of pieces of candidate imaging information based on the flickering frequency of the candidate imaging information in combination with the flickering frequency of the light-emitting source, so as to obtain the imaging information corresponding to the light-emitting source.

21. The method according to claim 19, wherein the step x comprises:
performing threshold binarization to imaging information in the plurality of difference imaging frames, respectively, so as to generate a plurality of candidate binarization images;
merging the plurality of candidate binarization images so as to obtain the frame processing result.

22. The method according to claim 19, wherein the step x comprises:
merging the plurality of difference image frames, so as to obtain a merged difference imaging frame;
performing frame image processing to the merge processed difference imaging frame, so as to obtain the frame processing result.

23. The method according to claim 1, wherein the light-emitting source comprises a moving light-emitting source, wherein the method further comprises:
determining that the exposure frequency of the camera is more than twice of the flickering frequency of the light-emitting source;
obtaining a consecutive plurality of imaging frames, wherein the consecutive plurality of imaging frames each comprises a plurality of pieces of imaging information;
performing difference calculation to every two adjacent imaging frames in the consecutive plurality of imaging frames, so as to obtain difference imaging information.
detecting a moving light spot in the consecutive plurality of imaging frames and trace information of the moving light spot;
wherein, the step a comprises:
taking the moving light spot as the candidate imaging information;
wherein, the step b comprises:
determining a flickering frequency of the candidate imaging information based on the trace information of the moving light spot in combination with the difference imaging information;
wherein, the step c comprises:
screening the plurality of pieces of candidate imaging information based on the flickering frequency of the candidate imaging information in combination with the flickering frequency of the light-emitting source, so as to obtain the imaging information corresponding to the light-emitting source.

24. An apparatus of screening imaging information of a light-emitting source, wherein the apparatus comprises:
an imaging obtaining means for obtaining a plurality of pieces of candidate imaging information in an imaging frame of a light-emitting source;
a feature obtaining means for obtaining feature information of the candidate imaging information;
an imaging screening means for screening the plurality of pieces of candidate imaging information based on the feature information, so as to obtain imaging information corresponding to the light-emitting source.

25. The apparatus according to claim 24, wherein the imaging screening means is for:
screening the plurality of pieces of candidate imaging information based on the feature information in combination with a predetermined feature threshold, so as to obtain the imaging information corresponding to the light-emitting source.

26. The apparatus according to claim 24, wherein the imaging screening means is for:
screening the plurality of pieces of candidate imaging information based on a maximum possibility of the feature information, so as to obtain the imaging information corresponding to the light-emitting source.

27. The apparatus according to claim 24, wherein the feature information comprises a light spot variation pattern, wherein the feature obtaining means is for:
detecting a light spot variation pattern of the candidate imaging information;
wherein, the imaging screening means is for:
matching the light spot variation pattern with a predetermined light spot variation pattern of the light-emitting source so as to obtain corresponding first match information;
based on the first matching information, screening the plurality of pieces of candidate imaging information so as to obtain the imaging information corresponding to the light-emitting source.

28. The apparatus according to claim 27, wherein the light spot variation pattern comprises at least one of the following items:
bright-dark alternative variation;
wavelength alternative variation
light spot geometrical feature variation;
flicker frequency alternative variation;
brightness distribution alternative variation.

29. The apparatus according to claim 24, wherein the imaging screening means is for:
screening the plurality of pieces of candidate imaging information based on the feature information in combination with background reference information corresponding to the light-emitting source, so as to obtain imaging information corresponding to the light-emitting source.

30. The apparatus according to claim 29, wherein the apparatus further comprises a background obtaining means for:
obtaining a plurality of pieces of zero input imaging information corresponding to the light-emitting source in a zero input state;
performing feature analysis of the plurality of pieces of zero input imaging information to obtain the background reference information.

31. The apparatus according to claim 24, wherein the apparatus further comprises a clustering means for:
clustering the plurality of pieces of candidate imaging information, so as to obtain an imaging clustering result;
wherein, the feature obtaining means is for:
extracting a clustering feature corresponding to the imaging clustering result, to act as the feature information.

32. The apparatus according to claim 24, wherein the feature obtaining means is for:
obtaining the feature information of the candidate imaging information based on imaging analysis of the candidate imaging information;
wherein the feature information comprises at least one of the following items:
wavelength information of a light source corresponding to the candidate imaging information;
flickering frequency corresponding to the candidate imaging information;
brightness information corresponding to the candidate imaging information;
light emitting pattern corresponding to the candidate imaging information;
geometrical information corresponding to the candidate imaging information;
distance information between the light source corresponding to the candidate imaging information and the camera;
color distribution information corresponding to the candidate imaging information.

33. The apparatus according to claim 24, wherein the feature obtaining means is for:
obtaining the feature information of the candidate imaging information based on imaging analysis of the candidate imaging information, wherein the feature information comprises wavelength information and/or flickering frequency of a light source corresponding to the candidate imaging information.

34. The apparatus according to claim 24, wherein the feature obtaining means is for:
obtaining the feature information of the candidate imaging information based on imaging analysis of the candidate imaging information, wherein the feature information comprises a light emitting pattern corresponding to the candidate imaging information.

35. The apparatus according to claim 24, wherein the feature obtaining means is for:
obtaining the feature information of the candidate imaging information based on imaging analysis of the candidate imaging information, wherein the feature information comprises geometrical information corresponding to the candidate imaging information.

36. The apparatus according to claim 24, wherein the feature obtaining means is for:
obtaining feature information of the candidate imaging information based on the imaging analysis of the candidate imaging information, wherein the feature information comprises distance information between the candidate imaging information and a target object.

37. The apparatus according to claim 24, wherein the feature obtaining means is for:
obtaining feature information of the candidate imaging information based on imaging analysis of the candidate imaging information, wherein the feature information comprises color distribution information corresponding to the candidate imaging information;
wherein, the imaging screening means is for:
matching the color distribution information corresponding to the candidate imaging information with a predetermined color distribution information so as to obtain corresponding second match information;
based on the second match information, screening the plurality of pieces of candidate imaging information so as to obtain imaging information corresponding to the light-emitting source.

38. The apparatus according to claim 24, wherein the apparatus further comprises:
a first frame obtaining means for obtaining any two imaging frames of the light-emitting source, wherein the any two imaging frames comprises a plurality of pieces of imaging information;
a first difference calculating means for performing difference calculation to the any two imaging frames, so as to obtain a difference imaging frame of the light-emitting source, wherein the difference imaging frame comprises difference imaging information;
wherein, the imaging obtaining means is for:
obtaining difference imaging information in the difference imaging frame, to act as the candidate imaging information.

39. The apparatus according to claim 24, wherein the light-emitting source comprises a moving light-emitting source, wherein the apparatus further comprises:
a second frame obtaining means for obtaining a consecutive plurality of imaging frames before the current imaging frame of the light-emitting source, wherein the consecutive plurality of imaging frames each comprises a plurality of pieces of imaging information;
a first detecting means for detecting a moving light spot in the consecutive plurality of imaging frames and trace information of the moving light spot;
a first predicting means for determining predicted position information of the moving light spot in the current imaging frame based on the trace information of the moving light spot in combination with a motion model;
wherein, the imaging obtaining means is for:
obtaining a plurality of pieces of candidate imaging information in the current imaging frame;
wherein, the imaging screening means is for:
screening the plurality of pieces of candidate imaging information based on the feature information in combination with the predicted position information, so as to obtain the imaging information corresponding to the light-emitting source.

40. The apparatus according to claim 39, wherein the motion model comprises at least one of the following items:
speed-based motion model;
acceleration-based motion model.

41. The apparatus according to claim 39, wherein the apparatus further comprises an updating means for:
updating the motion model based on the trace information in combination with position information of the candidate imaging information in the current imaging frame.

42. The apparatus according to claim 24, wherein the apparatus further comprises:
a first frequency determining means for determining a flickering frequency of the light-emitting source;
a frame number determining means for determining the frame number of the consecutive plurality of imaging frames obtained before the current imaging frame of the light-emitting source based on an exposure frequency of a camera and the flickering frequency of the light-emitting source, wherein the exposure frequency of the camera is more than twice of the flickering frequency of the light-emitting source;
a third frame obtaining means for obtaining the consecutive plurality of imaging frames before the current imaging frame based on the frame number, wherein the current imaging frame and the consecutive plurality of imaging frames each comprises a plurality of pieces of imaging information;
a second difference calculating means for performing difference calculation between the consecutive plurality of imaging frames and the current imaging frame, respectively, so as to obtain a plurality of difference imaging frames of the light-emitting source;
a frame image processing means for performing frame image processing to the plurality of difference imaging frames, so as to obtain a frame processing result;
wherein, the imaging obtaining means is for:
screening a plurality of pieces of imaging information in the current imaging frame based on the frame processing result, so as to obtain the candidate imaging information.

43. The apparatus according to claim 42, wherein the feature obtaining means is for:
determining a flickering frequency of the candidate imaging information based on imaging analysis of the candidate imaging information in combination with the frame processing result;
wherein, the imaging screening means is for:
screening the plurality of pieces of candidate imaging information based on the flickering frequency of the candidate imaging information in combination with the flickering frequency of the light-emitting source, so as to obtain the imaging information corresponding to the light-emitting source.

44. The apparatus according to claim 42, wherein the frame image processing means is for:
performing threshold binarization to imaging information in the plurality of difference imaging frames, respectively, so as to generate a plurality of candidate binarization images;
merging the plurality of candidate binarization images so as to obtain the frame processing result.

45. The apparatus according to claim 42, wherein the frame image processing means is for:
merging the plurality of difference image frames, so as to obtain a merged difference imaging frame;
performing frame image processing to the merge processed difference imaging frame, so as to obtain the frame processing result.

46. The apparatus according to claim 24, wherein the light-emitting source comprises a moving light-emitting source, wherein the apparatus further comprises:
a second frequency determining means for determining that the exposure frequency of the camera is more than twice of the flickering frequency of the light-emitting source;
a fourth frame obtaining means for obtaining a consecutive plurality of imaging frames, wherein the consecutive plurality of imaging frames each comprises a plurality of pieces of imaging information;
a third difference calculating means for performing difference calculation to every two adjacent imaging frames in the consecutive plurality of imaging frames, so as to obtain difference imaging information.
a second detecting means for detecting a moving light spot in the consecutive plurality of imaging frames and trace information of the moving light spot;
wherein, the imaging obtaining means is for:
taking the moving light spot as the candidate imaging information;
wherein, the feature obtaining means is for:
determining a flickering frequency of the candidate imaging information based on the trace information of the moving light spot in combination with the difference imaging information;
wherein, the imaging screening means is for:
screening the plurality of pieces of candidate imaging information based on the flickering frequency of the candidate imaging information in combination with the flickering frequency of the light-emitting source, so as to obtain the imaging information corresponding to the light-emitting source.
